(19) United States
(12) Patent Application Publication
(10) Pub. No.: US 2007/0106593 A1
(43) Pub. Date: May 10, 2007

(54) Adaptive stochastic transaction system

(76) Inventor: Grant Lin, Arcadia, CA (US)

Correspondence Address: John F. O'Rourke;Wang, Hartmann & Gibbs, P.C, Suite 1050, 1301 Dove Street, Newport Beach, CA, 92660, US

(21) Appl. No.: 11/268,332

(22) Filed: Nov. 7, 2005

(51) Int. Cl. G06Q 40/00

(52) U.S. Cl. 705/37

(57) ABSTRACT

An adaptive stochastic transaction system in which a vendor or first transactor offers a trade object to a vendee or second transactor at a variable, stochastic offer value formed from a pseudorandom value. The vendor communicates the stochastic offer value to the vendee in the form of a stochastic decision tuple, including an offer interval signifying the validity period of the offer value. The tuple is formed and communicated to incline the vendee to accept the offer for the trade object. The system is adaptive in that vendee and communication system responses are monitored to maximize transaction system enterprise parameters.

### BACKGROUND

1. Field of the Invention

The present invention generally relates to transaction systems and particularly to commercial transaction systems, for example, business-to-consumer transaction systems.

2. Background Art

Commercial transactions and transaction systems can be traced back into human prehistory. In a simple archetypal transaction, two parties exchange or agree to exchange respective objects. In general, the desirability of an object to a given party may be determined by both objective factors (e.g., scarcity) and subjective factors (e.g., symbolism), which factors may be independent, correlated, or a combination thereof. Taken together, the factors correspond to the value ascribed to a particular object. Although objective factors may be determinable to both parties, subjective factors often may be less so. Thus, an object may be valued differently by the respective parties intending to exchange objects. Typically, parties intending to effect an exchange undertake some form of interaction, by which the prospective traders reach a meeting of the minds on the terms of trade. These interactions are an essential prerequisite to nearly every type of transaction. For a given exchange, a series of such interactions may be called a negotiation. Over time, structured protocols, including formal negotiations, have evolved to facilitate certain transactions. Many everyday transactions, however, rely on informal negotiations for the trading parties to reach an accord.

To facilitate trading between parties drawn from a diverse range of social and political groups living in disparate geographic locations, the use of a common substitute object as an intermediate medium of exchange was long ago devised as a necessary convenience. Fundamental to this common intermediate construct is the principle that the common substitute object was ascribed a value which as generally agreed upon by all transacting parties. In one form, the common substitute is called money. Money allows two parties to effect a transaction, in which one party (here, the buyer) provides money to the other party (here, the seller), in exchange for the desired object. The seller may then exchange received money for objects desired by the seller. In the former transaction, a seller represents the value of an exchange object with a characteristic called a price.

Another fundamental principle of transactions is the notion of fairness. Usually, the seller intends to sell an object at the highest attainable price, with the difference in value between his cost and the selling price representing his profit. Parties typically understand that the seller may obtain some profit from a transaction, and that the price the buyer is willing to pay represents the most that a buyer wishes to pay for the particular object. Customarily, the fairness of a transaction can be profoundly and negatively affected by deception or manipulation of the price or quantity of an object by a buyer, a seller, or a third party. At the same time, a transaction is considered to be fair if the objects to be exchanged have comparable value to the transactors. If a transaction, or deal, is considered to be fair, both buyer and seller are likely to execute the transaction. If not, the party perceiving to receive significantly less value for the exchanged object, for example, than the price paid,

The fairness of a transaction may be influenced, often significantly, by subjective trading factors outside the knowledge of one party or the other. Frequently, subjective factors are used to determine whether the trading parties find enough parity in the terms of the trade to allow a deal to move forward to completion. A transaction is likely to proceed, where there is some degree of parity in the values of the objects sought to be exchanged. An exchange that is deemed to be a roughly even trade is deemed to be fair, but only after protracted negotiations to achieved an acceptable degree of parity. On the other hand, transaction believed to be very favorable to a party, may lead that party to instinctively and quickly agree to the expressed terms, eliminating further negotiation. For example, if a buyer obtains a desired object at a price lower than the price identified by the buyer as the point of parity, then the buyer would consider the trade to be a “good” deal. If the offered price is well below the buyer's point of parity, or a subjective factor known to the buyer indicates that there is additional, unobvious value to be gained in the trade, the buyer may deem the deal to be a “great” deal, that is, a bargain. Unknown and subjective factors may facilitate an individual deal but, overall, such factors may impede trade.

For transacting parties, it is desirable for each to have information about the other, and about the object of trade. A decision by a transacting party to accept the validity of the information about the other party, and the transaction, can be expressed as trust. Two parties who trust each other are more likely to complete a transaction quickly. The buyer's trust in the seller indicates the buyer's belief that the seller is not misrepresenting trade intentions, price, or trade object values. A seller's trust in the buyer indicates that the seller believes that the buyer will tender payment of the agreed-upon price, on the terms promised. Buyers and sellers who engage in series of “good” or “fair” deals tend to return to each other for additional transactions. If a party considers the other as untrustworthy, or as one who is not fair or willing to give a good deal, then the party becomes disinclined to deal with the “unfair” other.

The acts of third parties may skew, distort, or corrupt one or more transactions, which when discovered, tend to dissuade the transactors from executing a trade. If the method by which a seller executes transactions is untrustworthy, that is, can be corrupted or manipulated by third parties, buyers are unlikely to return in the future to engage in commerce with that seller. Typically, it is in the best interests of both parties to engage in fair transactions, and to use trustworthy methods of transactions.

As the nature of transactions becomes more complex, buyers and sellers both tend to seek out the most trustworthy trading partners with whom to do business. Trust, then can improve trading relationships among parties, and can provide an environment supportive to the execution of efficient transactions.

Transactions often involve more than just one buyer and one seller. Such transactions may introduce a competitive element into the relationship between a seller and a buyer. In one form of competitive transaction, two or more buyers compete to offer to the seller, i.e., bid, the highest price that the respective buyer is willing to pay for the object. A seller may offer an object to the buyers at an established price. One buyer may place a bid for the object at or above the established price, intending to buy the object. The seller may accept the offered bid, or indicate a desire to receive a higher bid by asking a higher price. Another buyer, who may place a higher value on the object than the first buyer, often places a bid representing a willingness to pay that higher price. Again, the seller may accept this bid, or may solicit a higher bid by raising the asking price. Again, either previous bidder, or another buyer may place a bid corresponding to the higher asking price. Again, the seller may accept or reject this new bid. The process of ask and bid repeats until the buyers indicate an unwillingness to buy at the current asking price. Usually, the seller will conclude the transaction by accepting the highest accepted bid, after which the successful buyer makes payment or agrees to make payment, to receive the object. In this scenario, termed a forward auction, the buyers are offerors who place bids, which individually represent the price that respective buyers are willing to pay for an object. In general, the bids are made such that the bid price increases monotonically during the evolution of the auction. The price paid by the buyer is usually higher than the initial established price, or the first bid.

Some auctions may reverse the roles of offeror and offeree. For example, in a reverse auction, the seller is the offeror, stating an initial maximum offer price for an object. Here, it is the buyers who either accept or reject the offer. If the buyers reject the seller's offer, or if additional inventory must be sold, the seller states a new, lower offer price for the objects. Again, buyers may accept or reject the offer. A seller may repeat the process of sequentially decreasing offer prices until inventory is depleted. Although this method gives buyers the incentive to wait until the seller offers the lowest possible price, the buyers usually know that the objects being auctioned are considered to be scarce and needed. Generally, demand increases as prices decline. As the reverse auction progresses, the seller's inventory tends to dwindle. A decision to delay accepting the seller's offer at a given price is made at the peril of the seller's inventory being exhausted before the reluctant buyer secures the desired number of objects. Typically, the price paid for an object during a reverse auction is lower than the initial offer price. When a buyer agrees to a trade, the price paid is usually higher than the final price that will be paid by the final buyer. Thus, a buyer must balance the desire to buy at the lowest desired price against the reality of an increase in demand, and inventory exhaustion, before the lowest desired price is reached.

There are myriad types of transaction systems used for commercial exchanges, including those undertaken for public utility resource allocation, for institutional purchases, for routine commercial exchanges, and even for personal enjoyment. Auctions, bazaars, swaps, barter exchanges, and similar transactions involving negotiations and structured exchange protocols, are among the most popular transaction systems at nearly every level of exchange. These systems meet the need for buyer and seller to interact, often in real time, to assure that each meets their expectations for the desired bargain. Despite the convenience of established transactions, some buyers may desire a transaction system that offers opportunities to effect exchanges with a degree of excitement, spirited exchange, and an illusion of risk, without the actual risk usually associated with gaming systems and games of chance and luck.

As noted above, a buyer must place some degree of trust is in the buyer and in the transaction method. For example, the buyer must trust the seller to accurately represent the goods offered for sale and to surrender purchased goods to the buyer, as promised. The seller must trust the buyer to surrender the agreed-upon amount of money, or an object of comparable value, in exchange for the object exchanged. Both seller and buyer place some trust in the system by which the transaction is executed. On one hand, the buyer must trust that the seller has not introduced persons or techniques that place undue influence on transactions, perhaps causing the buyer to pay more for an object than would otherwise be paid. On the other, the seller must trust that there is no collusion among buyers to manipulate the transaction system to unduly influence transactions to the detriment of the seller. Similarly, a buyer must trust that the transaction system may not be manipulated by the seller and another potential buyer, or by a group of colluding buyers, to distort the transactional process.

Even when both buyer and seller have well-founded trust in each other, and in the transactional system to be used to effect their commercial exchange, the system may be at risk from unscrupulous parties who seek to exploit weaknesses in the transactional process to their advantage and gain. Some exploiters may use purloined historical, demographical, or personal information about the buyer or seller to siphon profits from the transaction profits. Others may surreptitiously monitor the transaction system to identify trade correlations and predict future prices or transaction trends, allowing the exploiter to cash in on the illicit knowledge. Such disreputable practices can be especially burdensome for many types of transactions.

For example, in highly-structured negotiations, such as auctions, process subversion, shilling, price and value manipulation, and other fraudulent, collusive, predatory, or entry-deterring behavior can substantially reduce the efficiency, fairness, and simplicity of the negotiations, particularly for recurring or parallel negotiations. A venue, in which such undesirable activities were perceived to hold sway, is likely to experience reduced profitability and loss of target clientele.

Perhaps more significantly, transactions which may be perceived as based on a potentially corruptible and unfair process, or as suitable only for those with special knowledge or skills, may discourage a substantial population of potential participants from engaging in those transactions. Unfortunately, market goers who are vexed and dissatisfied with explicit and implicit collusion, shilling, process manipulation, and the like, in online auctions, bazaars, swap sites, and other popular marketplaces may rarely, if ever, return. Additionally, costly measures such as conduct policing systems and reputational screening may be need to preserve an acceptable degree of integrity in the operation.

Nevertheless, motivated observers may seek unfair advantage, relevant information regarding a transaction, or class of transactions, as well as the corresponding transactional process. Skilled analysis of past process performance, as well as of the signals used during negotiations, also may permit the analyst to expressly or implicitly distort the transaction process and outcomes to an unfair advantage. Despite certain safeguards, unscrupulous conduct may be encouraged, before or during a transaction, by the open availability of information characterizing the trade object to be transacted; the trade object pricing, value, and authenticity; the transaction participants, and their likely behavior; the economic environment of the transaction, including financial state of the seller, broker, or both; as well as other uncovered private information relevant to the transaction. This information then may be used to unfairly extract significant profits for the dishonest actor.

It is desirable therefore, to provide a transaction system that minimizes, if not eliminates, the influence of collusion, unfair price manipulation, or other process corruption by unscrupulous parties. It also is desirable to provide a transaction system that, when adapted to do so, may provide a degree of excitement and spirited exchange, which may also exhibit an illusion of risk.

### SUMMARY OF THE INVENTION

The present invention satisfies at least the aforementioned needs, and others known to the field of transaction or trading systems by providing a trading system, including a vendor disposed to propose an object offer at an offer value; a vendee disposed to accept the object offer at a purchase value; and a communication link coupling the vendor and the vendee, by which the vendor and the vendee communicate object offer data. The object offer data includes a stochastic tuple related to the offer value. In accordance with the practice herein, the vendor proposes the object offer to the vendee through the communication link such that the vendee is induced to accept the object offer when the offer value is one of generally equal to and less than the purchase value.

The stochastic tuple includes a proposed offer value and an offer interval, with one or both of the proposed offer value and the offer interval being a stochastic variable value. Furthermore, aspects of the invention herein provide a sequence of stochastic tuples communicated by the vendor to the vendee during a defined transaction period. The object offer represents one of a product, a service, and a combination thereof. In certain embodiments, the vendor proposes the object offer within a preselected marketing schema chosen to entice the vendee to accept the object offer of the vendor. In selected ones of these embodiments, the preselected marketing schema comprises an interactive, multimedia entertainment schema.

### BRIEF DESCRIPTION OF THE DRAWINGS

The invention may be better understood, and further advantages and uses thereof made more readily apparent, when considered in view of the following detailed description of exemplary embodiments taken with the drawings in which:

FIG. 1 is a diagrammatic representation of an adaptive stochastic transaction system embodiment, according to the present invention;

FIG. 2 is a diagrammatic representation of an exemplary embodiment of an adaptive marketing module with stochastic data, according to the present invention;

FIG. 3 is a diagrammatic representation of data sequence corresponding to a stochastic process producing variable offer values as applied to inventive systems and modules herein;

FIG. 4 is a diagrammatic representation of data sequence corresponding to a stochastic process producing variable offer values and corresponding variable offer intervals as applied to inventive systems and modules herein;

FIG. 5 is a diagrammatic representation of data sequence corresponding to an adaptive stochastic process employing multiple selected variable offer values and corresponding variable offer intervals, as applied to inventive systems and modules herein;

FIG. 6 is an embodiment of an adaptive stochastic transaction system having an apparatus capable of generating a data sequence as illustrated in FIG. 3;

FIG. 7 is an embodiment of an adaptive stochastic transaction system having an apparatus capable of generating a data sequence as illustrated in FIG. 4;

FIG. 8 is an embodiment of an adaptive stochastic transaction system having an apparatus capable of generating a data sequence as illustrated in FIG. 5;

FIG. 9 is an embodiment of a graphical user interface, which may be presented and perceived by a prospective buyer, using selected embodiments of the present transaction;

FIG. 10 is an illustration of certain embodiments of the inventive transaction system in the context of a commercial enterprise; and

FIG. 11 is a diagrammatic representation of data sequence corresponding to an adaptive stochastic process employing selected variable offer values and corresponding variable inventory intervals, as applied to inventive systems and modules herein.

### DETAILED DESCRIPTION OF THE EMBODIMENTS

Embodiments of the present invention encompass an adaptive stochastic transaction system, method, and computer-readable article of manufacture, in which one entity is constituted to communicate, over a communication route, a stochastic decision token to at least one second entity, with the intention of inducing the at least one second entity to respond with a desired behavior to the stochastic decision token. The behavior can include the second entity responding to the stochastic decision token with a corresponding response token.

A transaction can describe a unit of exchange between the entities and may include a signaling protocol by which the entities indicate their respective transaction intentions. By means of a transaction, the signaling entities exchange a trade object for a trade value. In general, a trade object may be a product, a service, an asset, a resource, an allocation, or an equivalent, as well as a combination thereof. A trade value can be represented by another object, or by an agreed quantity of a defined medium of exchange (DME). In a commercial context, an example of a DME is cash. A transaction may be an actual exchange, or may be a commitment to exchange. In the latter case, the actual exchange is initially deferred and later completed by one or more ancillary communications or transfers. However, any tangible or intangible item, token, property, symbol, or trade object may represent a DME unit. Thus, DME may be represented by bandwidth, priority, power, access, tenure, or whatever other dimension transacting entities may deem as an acceptable DME.

As used herein, the term dimension is not limited to any of the three measures of length, breadth and height. Instead, as used herein, a dimension is a construct, scale, or categorization, describing a broad grouping of descriptive and potentially varying, data, or a state of being, whereby objects or individuals can be distinguished. As such, a dimension may include a construct, scale, or categorization, that is fundamental, is derived, or is a combination thereof; and which may be expressed, for example, in absolute, relative, or differential terms. Familiar examples of a dimension are time or length, which may be expressed respectively as a time of day or distance, a time or length offset, and time or length interval. By extension, an exemplary derived or combined dimension can be speed, derived from traversing an interval of length during an interval of time; or can be acceleration, derived from a difference in speed during an interval of time. Another non-limiting example of a dimension may include an absolute value or price; a relative value or price offset; or a difference in value or price. By extension, a dimension also may be price or price difference expressed as a function of time or time difference; of product inventory level or level change; of margin or margin difference; of sales volume or sales volume change; of bandwidth or bandwidth change; of a customer response, or demographic or market datum; of at least one preselected competitive enterprise indicators; and so on, whether alone or in combination. Where useful for exposition, the term, trade dimension, may be used, and is to be considered synonymous with other uses of the term, dimension.

A stochastic decision token includes at least one dimension representative of a trade object, which demonstrates stochastic characteristics over a domain, within in a range, or both. In general, a “stochastic” characteristic is one that is non-deterministic, and can be described, at least in pertinent part, by the laws of probability. That is, the dimension characteristics may be generated such that the next state of the dimension tends not to be fully determined by its previous state. For clarity, “stochastic” will be synonymous with “random,” encompassing the entire domain of non-deterministic features including, without limitation, stochastic and pseudo-random features, as well as stochastic and random features.

A single non-deterministic variable often is termed a random, or randomized, variable, with an ordered collection, or sequence, of random variables being called stochastic process. A stochastic dimension may be formed of a randomized portion alone, or of a randomized portion in combination with a deterministic portion. Although a future value of a stochastic sequence may not be ascertainable from previous values, a sequence may be devised to reflect a preselected mean and a preselected variance, with values being relatively dispersed within a preselected distribution envelope. Nevertheless, the randomized nature of the dimension can be preserved, even if a deterministic portion of a stochastic variable representing that dimension may be measured, and the corresponding mean value, variance, and distribution function can be ascertained. Within some contexts, metrics corresponding to a desired behavior may be described in terms of risk-taking, efficiency, error, Shannon entropy, and the like.

The first entity may adapt aspects of the system response to the behavior of the second entity, as well as to systemic factors. For example, in response to observed or anticipated behavior by the second entity, the first entity may modify the categories and quantity of trade objects available for exchange, modify access to transactions, manage information pertinent to transactions and trade objects, or shape DME-related, stochastically-derived, trade object attributes by selectively modifying a preselected stochastic process. Therefore, embodiments of transaction systems according to the teachings of the present invention can be configured to be self-adjusting, adaptive transaction systems.

Also, a communications route may be formed from at least one communications channel, which communications channel may be formed from at least one communications path. In turn, a communications path may be formed from at least one communication link. Each communications link includes at least one circuit, which serves as a medium for transferring information. This medium may transport information in analog or in digital form, using wired or wireless signal propagation techniques to carry information. The information may be conveyed by multiple communications formats and communications protocols. Therefore, a communication route may be capable of conveying information using, alone or in an operable combination, multiple communication channels and media, multiple signal propagation techniques, and multiple communications formats and communications protocols. Although bidirectional communication between parties is desirable, a communication effected in one direction between parties is not required to employ the same or similar channel, media, signal propagation technique, communications format, or communications protocol to effect a communication in any other direction.

Advantageously, features, aspects, and embodiments of the present invention may be disposed to provide a myriad of realized outcomes for the transacting parties. As used herein, the term “business operator” may include an enterprise, or back-office, executive, a seller, or both. In selected generalized implementations, a business operator may use multiple sellers and multiple types of trade objects during the course of enterprise operations.

Of course, in this context, the notion of business operator encompasses an apparatus which includes, without limitation, one or more of computing, sensing, communication, and networking subunits. A business operator also can be embodied in computer code embodied on a computer-readable medium that, when executed on a computing apparatus, causes the computer apparatus to perform an adaptive, stochastic transaction process, according to principles taught and described herein.

As intended herein, a business operator can receive information and business intelligence in the form of selected trade indicators and, responsive to those selected trade indicators, adapt business operations to the realities of both market and operational realities and events, in real-time or near-real time. The selected trade indicators can be drawn from any source within or surrounding the enterprise, which may be indicative of a market trend or circumstance important to the business owner. In many instances, a selected trade indicator may be related to one or more of the aforementioned trade dimensions.

An exemplary selected trade indicator may include, without limitation and alone or in combination: a trade object inventory, a trade object purchase price, a trade object availability, a trade object delivery, and trade object vendor selection and payments; a credit factor or a financing factor for the operation, a business operator, a seller, a vendor, or a buyer; measured or estimated buyer interest in one or more selected trade objects, purchasing trends, and buyer behavioral tendencies; geographic, regional, seasonal, temporal, and demographic factors; and buyer responses to trade object brands, terms of trade, seller styles and personalities, and so on.

Moreover, where a buyer is set off from the business operator, and effecting trade through a communications device or system, such as a telephone network or a public internetwork, exemplary selected trade indicators may include, without limitation and alone or in combination: telephone call volume, network bandwidth consumption, completed internetwork links, actual sales volume, volume of non-sale inquiries or comments, buyer responses to sales incentives, and the like.

A selected trade indicator may be one or more ratiometric and comparative measures of buyer interest, purchasing desire, and market conditions, such as a telephonic sale to telephonic contact ratio, an internetwork-related sales to total internetwork-related link ratio; a telephonic sales volume to internetwork sales volume ratio; contact and sales volume comparisons between and among geographic, demographic, special interest, collectors, and other real or virtual self-selected groups.

In general, then, a business operator may employ as a selected trade indicator as many or as few direct or indirect measures of buyer activity and behavioral predictors, geopolitical, socioeconomic and other quantifiable measures of trading activity, again, alone or in combination. A selected trade indicator may also be a combination of multiple other selected trade indicators, which may be combined linearly, non-linearly, or in combination.

Some embodiments of an adaptive stochastic transaction system may be configured to bias the adaptation of a process recited herein to a particular business outcome in favor of a seller; in certain instances, an improvement in the outcome realized by a seller is achieved at the expense of a buyer. If that expense is too great, the buyer may conclude that they overpaid for the trade object and did not receive a fair deal. The buyer tends to be discouraged from future transactions with that seller, because of the perceived negative transaction experience.

Other embodiments may be configured to bias adaptation of a process recited herein to a particular business outcome in favor of a buyer; in certain other instances, an improvement in the outcome realized by the buyer is achieved at the expense of the seller. For example, a seller may find necessity to reduce excess inventory at a substantial loss, and conclude that they ought not to continue offering the discounted trade object. The seller tends to be discouraged from future transactions with that buyer, also because of the perceived negative transaction experience.

Pragmatically, it is possible and often desirable, to provide selected embodiments of the present invention adapted to offer a win-win outcome to both transacting parties, akin to Pareto efficiency. In general, the perceived transaction experiences of both the seller and the buyer are positive with a perception of fair and successful dealing being held by both the seller and the buyer.

Adaptation can evolve from selected trade indicators, which provide the seller with relevant information and intelligence regarding the processes pertaining to the business operator's enterprise. A business operator may use selected trade indicators to adjust an adaptive stochastic transaction process herein to meet desired business objectives and to influence the behavior of the buyer in real-time, near-real-time, periodically, or episodically.

Adaptation also can evolve from a judgment action taken by the seller. A judgment action is a manual input which may be responsive to a selected trade indicator, or imposed by a human operator, in a manner that may appear “arbitrary.” However, such a judgment action can arise from a choice by the human operator that is generally intuitive and thus typically not measurable in traditional terms.

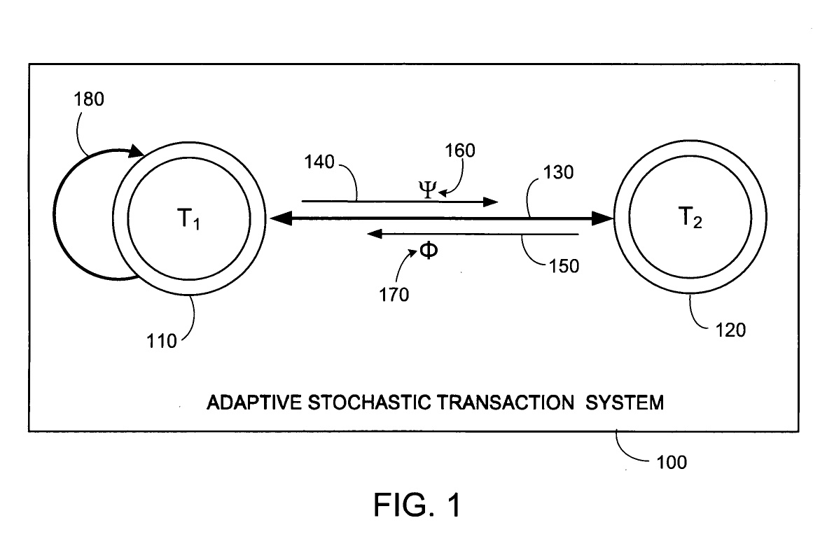

Turning now to the Figures, FIG. 1 represents an exemplary embodiment of adaptive, stochastic transaction system 100. Communications proceed by signaling according to a preselected transaction protocol, with respect to a defined transaction. The defined transaction can be a predefined trading event, conducted over a predefined trading interval. In system 100, first transactor T₁ 110 signals at least one stochastic decision token ψ 160, to second transactor T₂ 120; and is connectable with second transactor T₂ 120 through communication route 130, to so communicate. Communication route 130 typically includes uplink 140 and downlink 150. In general, once it is communicated from first transactor T₁ 110 over downlink 150 and perceived by second transactor T₂ 120, stochastic decision token ψ 160 is disposed to induce an observed behavior in second transactor T₂ 120. Stochastic decision token ψ 160 can be representative of a trade value presently associated with the preselected trade object (not shown), which is subject to the present transaction. In view of the stochastic nature of the trade value associated with stochastic decision token ψ 160, future trade values may be difficult to predict on the basis of past values. This property may be perceived as an element of risk.

Although difficult prediction of future values, and financial risks, may be undesirable to some persons in other types of transactions, it can be desirable in the context of the present invention, because it is well-known that small risks of many types can be both stimulating and enjoyable for many individuals except, perhaps, for the most risk-averse. Therefore, the stochastic characteristics as employed, for example, in transaction systems according to the present invention, may be affectively stimulating and enjoyable, particularly if the transaction system is embodied within an entertainment milieu.

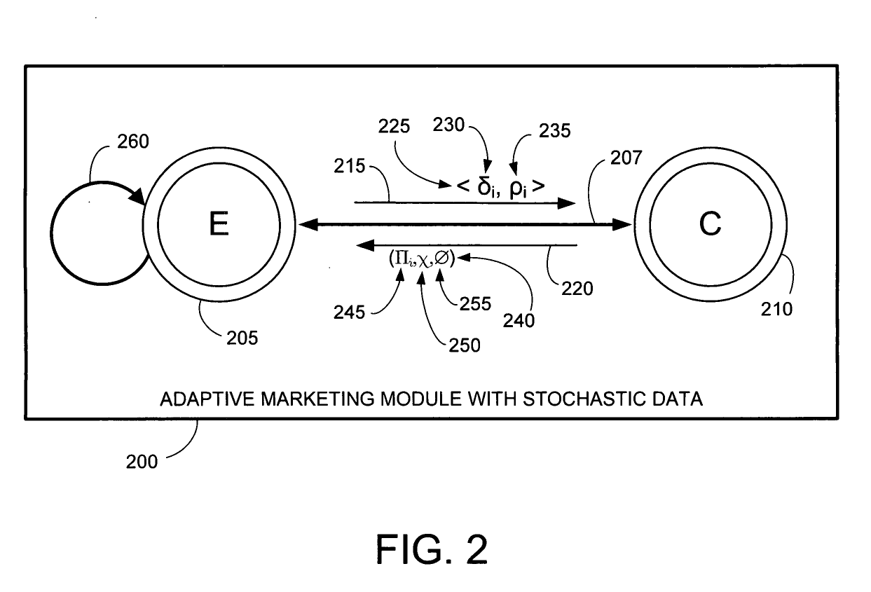

FIG. 2 illustrates business-to-consumer enterprise system 200, which can be similar to adaptive, stochastic transaction system 100, described in FIG. 1. Enterprise system 200 includes enterprise host module 205 (i.e., seller 205), which is coupled to bidirectional communication channel 207, and which thereby can connect to at least one consumer module 210 (i.e., buyer 210). When connected through channel 207, seller 205 and buyer 210 may engage in a transaction for one or more preselected trade objects using a preselected trade protocol. Channel 207 can include at least uplink 215 and downlink 220, and it may be desirable that one or more selected links in communication route 207 be a multimodal, bidirectional communication channel, capable of multimedia transmissions and, further, of one or more of asynchronous, isochronous, broadcast, or multicast, communications, using wired and wireless signal communication techniques.

Further, communication route 207 can provide one or more communication links that traverse a point-to-point communication network, a circuit-switched communication network, a store-and-forward communication network, a packet-switched communication network, a broadcast communication network, and a combination thereof. An exemplary communication network presently having store-and-forward and packet-switched features, with quality-of-service-aware capabilities (e.g., isochronous, asynchronous, etc.), may include a packet-switched communications internetwork, such as the Internet. Another type of communication network, the public switched telephone network, is an example of a circuit-switched network facilitating point-to-point communications. Likewise, an interactive producer-to-consumer satellite-based broadcast network may exemplify an exemplary broadcast communication network, which also include a cable-access (CATV) link. Furthermore, present wireless mobile communication devices enable hand-held multimedia communication with text messaging, video, audio, and stored program features.

Thus, although communication route 207 may employ a single mode and class of communication network, or link, is within the scope of the present invention that communication between parties may be accomplished using multiple modes, links, and classes of communications entities. For example, the communication path and nature of components constituting uplink 215 may be distinct from those constituting downlink 220. Indeed, in selected embodiments of the present invention, at least a portion of uplink 215 may include a broadcast network, by which a video presentation of a transaction is televised from seller 205 to buyer 210. In addition, at least a portion of downlink 220 may include a computer internetwork, such as the Internet, or a public telephone network, by which buyer 210 may respond to a televised presentation by seller 205.

While in FIG. 1, first transactor T₁ 110 signals at least one stochastic decision token ψ 160, to second transactor T₂ 120, in FIG. 2, seller 205 is disposed to signal at least one stochastic decision tuple 225 to buyer 210 through downlink 215. As before, seller 205 signals buyer 210 with a query described by stochastic decision tuple 225, with the intention of inducing buyer 210 to respond to stochastic tuple 225 with a desired behavior. In general, once perceived by buyer 210, stochastic decision tuple 225 is disposed to induce an observed behavior in buyer 210, including a response to seller 205. Desirably, stochastic decision tuple 225 is an ordered set of one or more dimensions associated with an intended transaction between seller 205 and buyer 210. At least a portion of one dimension is generated by buyer 205 as a stochastic portion, as indicated previously.

Stochastic decision tuple 225 may be, for example, a singleton or a duplet, which are sets having one element and two elements, respectively. An exemplary singleton may contain an element or dimension, which is stochastic in part or in whole. For example, offer value ρ 235, can be generated from a base value, which is summed with a randomized value, and can be representative of a trade value associated with the preselected trade object (not shown) presently being transacted. An exemplary duplet may contain two dimensions, for example, offer value ρ 235 and offer interval δ 230, at least one of which being. stochastic in part, or in total. Tuple 225 also may include three or more values, at least one of which also being stochastic in nature.

Although tuple 225 may contain multiple dimensions of information, it nevertheless can be adapted to form a compact token, as may be desirable to minimize the resources used to facilitate one-to-many transmission, such as transmission time and power, channel capacity, bandwidth, and so on. Thus, whether seller 205 is connected simultaneously through channel 207 to one buyer 210, or to one hundred thousand buyers 210, it may be sufficient to simultaneously query buyer(s) 210 with one stochastic decision tuple 225.

For clarity, stochastic decision tuple 225 is described in terms of a stochastic two-element set <δ,ρ>. Set element δ 230 can be representative of an offer interval, or the time over which a corresponding offer value may be considered valid. That is, upon expiration of offer interval δ 230, paired offer value ρ 235 is revoked. Similarly, set element ρ 235 can be representative of an offer value, or present stated cost for a trade object. Also, where offer tuple 225 is one of an ordered sequence of stochastic tuples signaled over time to buyer 210, interval δ 230 and offer value ρ 235 can be indexed to their respective order in the associated time sequence, such that tuple 225 can be symbolized by <δᵢ,ρᵢ>. One or both of offer interval δᵢ 230 and offer value ρᵢ 235 can be stochastic. However, when only one element of a duplet 225 is stochastic, it is desirable that offer value ρᵢ 235 be randomized.

In certain embodiments, the preselected trade protocol describes a trading event during which a preselected trade object may be offered to buyer 210. The span of a trading event can be subject to one or more limitations, such as a predefined trading interval Δ, a preselected trade object count and so forth. A predefined trade object count can be a trading event inventory (i.e., the maximum number of trade objects allocated for a given trading event), or a total trade object inventory (i.e., the maximum number of trade objects available for allocation).

Typically, the span of a trading event Δ_{N} can be described in terms of the time represented by the maximum number N of predefined offer intervals allocated to the trading event. For example, if the maximum span of trading interval Δ encompasses N offer intervals δᵢ 230, then trading interval Δ_{N} may be described as the sum of N offer intervals δᵢ 230. Symbolically:

$$Δ = {\sum }_{i = 1}^{N} {\partial }_{i}$$

Ordinarily, seller 205 signals stochastic tuple <δᵢ,ρᵢ>. 225 to buyer 210 prior to the an i^{th} offer interval, for example, during the (i−1)^{th} offer interval, thereby indicating that the i^{th} offer interval will have a duration of δᵢ, during which the preselected trade object will be offered at a offer value of ρᵢ. When ρᵢ is generated as a stochastic variable, the offer values ρ₁, ρ₂, . . . , ρ_{N} can be perceived by buyer 210 as varying randomly, even if within a predefined range of values. Moreover, offer values ρ₁, ρ₂, . . . , ρ_{N} also may appear to be generally random and uncorrelated to an unscrupulous observer attempting to manipulate future offer values of a trading event on the basis of past values or to otherwise use process, participant, or trade object information to subvert the commercial process evolving between seller 205 and buyer 210. Such disreputable practices can be especially burdensome for some types of transactions.

For example, in highly-structured negotiations, such as auctions, process subversion, shilling, price and value manipulation, and other fraudulent, collusive, predatory, or entry-deterring behavior can substantially reduce the efficiency, fairness, and simplicity of the negotiations, particularly for recurring or parallel negotiations. A venue in which such undesirable activities were perceived to hold sway, is likely to experience reduced profitability and loss of target clientele.

Perhaps more significantly, transactions which may be perceived as based on a potentially corruptible and unfair process, or as suitable only for those with special knowledge or skills, may discourage a substantial population of potential participants from engaging in those transactions. Unfortunately, market goers who are vexed and dissatisfied with explicit and implicit collusion, shilling, process manipulation, and the like, in online auctions, bazaars, swap sites, and other popular marketplaces may rarely, if ever, return. Additionally, costly measures such as conduct policing systems and reputational screening may be needed to preserve an acceptable degree of integrity in the operation.

Nevertheless, motivated observers may seek unfair advantage, relevant information regarding a transaction, or class of transactions, as well as the corresponding transactional process. Skilled analysis of past process performance, as well as of the signals used during negotiations, also may permit the analyst to expressly or implicitly distort the transaction process and outcomes to an unfair advantage. Despite certain safeguards, unscrupulous conduct may be encouraged, before or during a transaction, by the open availability of information characterizing the trade object to be transacted; the trade object pricing, value, and authenticity; the transaction participants, and their likely behavior; the economic environment of the transaction, including financial state of the seller, broker, or both; as well as other uncovered private information relevant to the transaction. This information then may be used to unfairly extract significant profits for the dishonest actor.

Thus, the use of stochastic decision tuple 225 can be a desirable transactional signaling device, because an observer of a stochastic process may not be able to predict, with a reasonable degree of certainty, a future value of a randomized element from a previous value, even if general characteristics of the process are known or can be determined. As a result, stochastic transaction signaling according to the embodiments herein, provides an elegant, effective barrier to process subversion, collusion, and similar undesirable influences, because of the onus of extracting timely, useful information from the stochastic transaction signals, which seller 205 communicates to buyer 210.

Generally, one aspect of the preselected trading protocol involves seller 205 signaling buyer 210 with stochastic decision tuple <δᵢ,ρᵢ> 225 prior to the beginning of the i^{th} period of trading interval Δ_{N}. Dimension δᵢ 230 represents the duration of i^{th} period of trading interval Δ_{N}. Although trading interval Δ_{N}, may be predefined, it also may be determinable by a seller. Of course, a buyer may terminate involvement in a trade by discontinuing involvement in the trade. Trade will continue if other buyers are participating in the trade, and sufficient inventory is available. Dimension ρᵢ 235 represents the offer value to be asserted during the i^{th} offer interval.

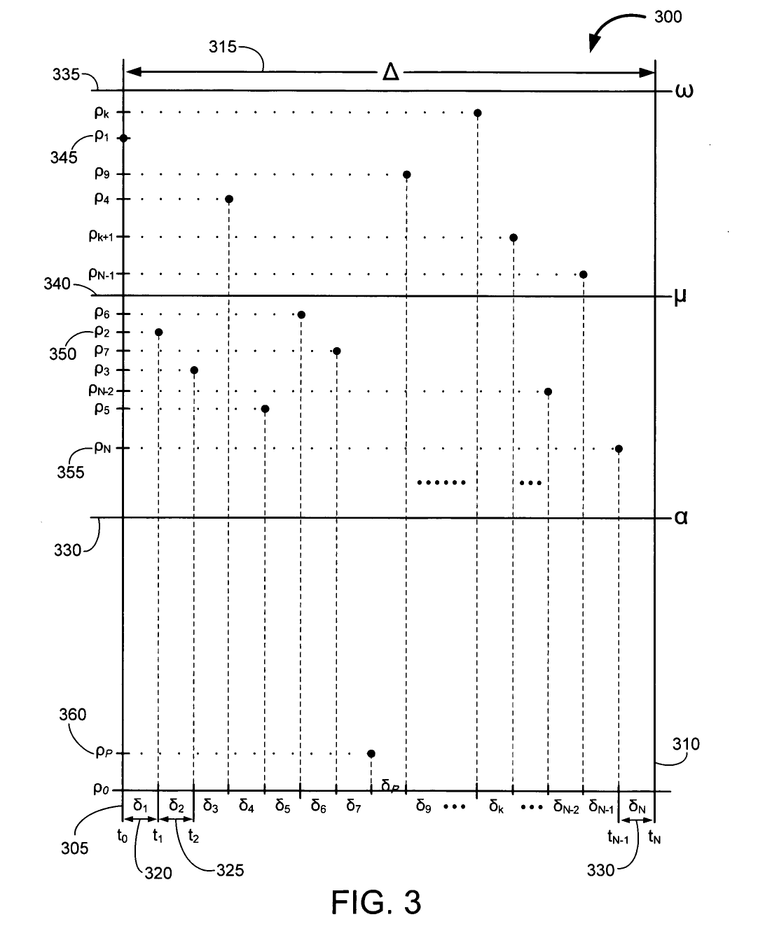

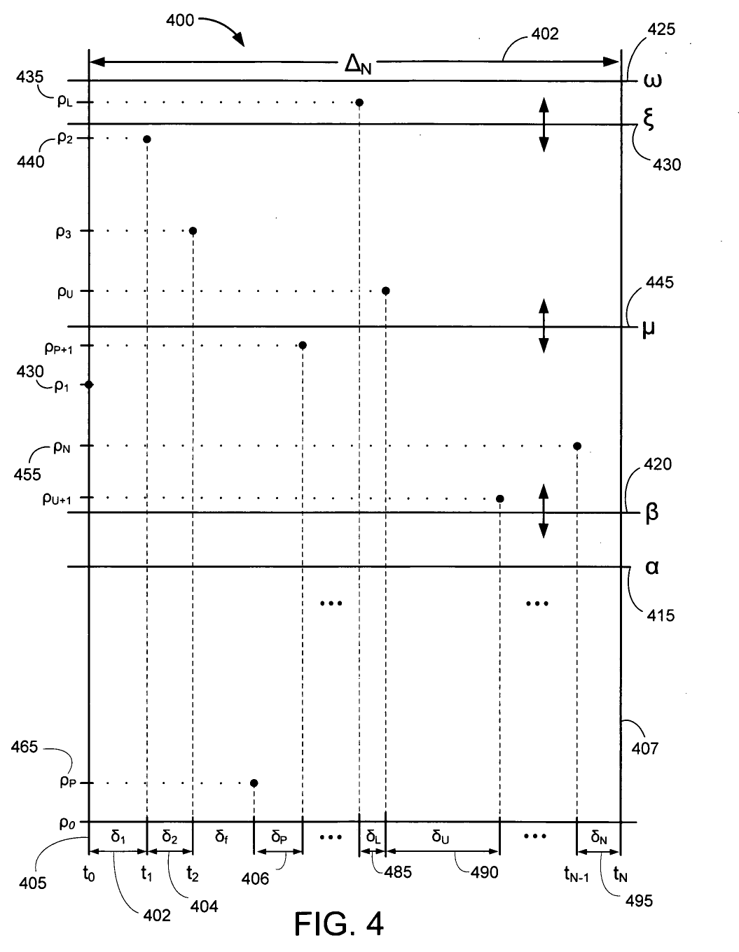

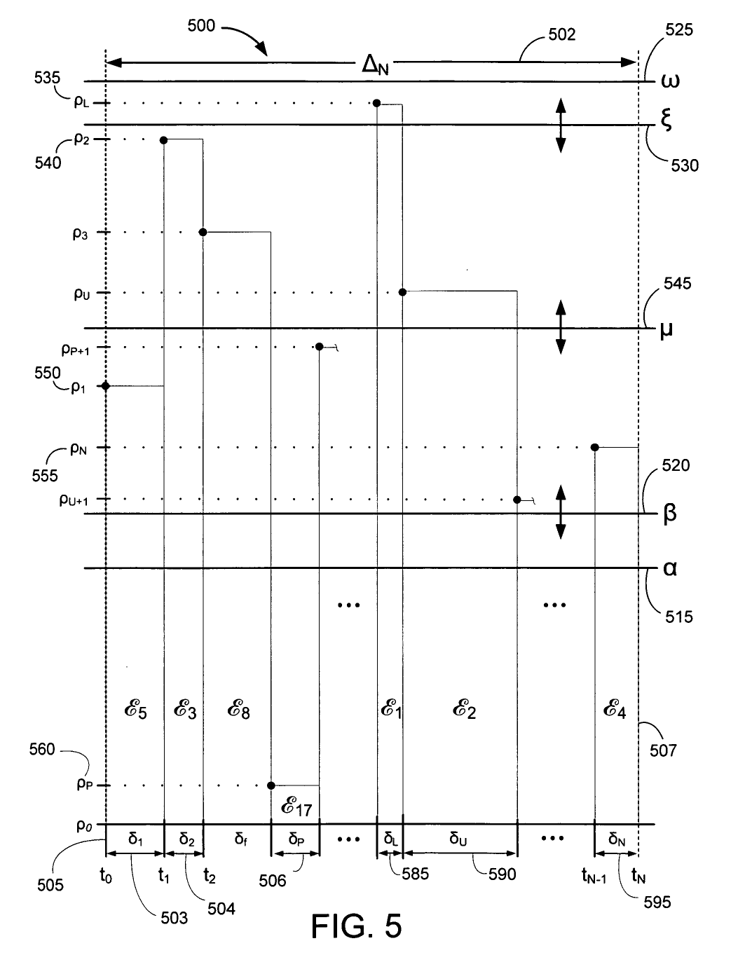

Thus, stochastic decision tuple <δᵢ,ρᵢ> 225 is representative both of a time dimension and a cost/price dimension, and is a signal to buyer 210 from seller 205 that, starting from the beginning of the i^{th} period and lasting only for an interval of δᵢ 230, buyer 210 may take the trade object of the transaction at a value of ρᵢ 235. However, after offer interval δᵢ 230 elapses, the offer value of ρᵢ 235 is revoked and invalid. Should buyer 210 wish to take the trade object, the next opportunity to do so will occur during the (i+1)^{th} period of trading interval Δ_{N}, with subsequent stochastic decision tuple <δᵢ₊₁,ρᵢ₊₁> 225 describing subsequent offer value ρᵢ₊₁ 235 and the subsequent offer interval δᵢ₊₁ 230 during which offer value ρᵢ₊₁ 235 will be considered to be valid. In general, if ρ is a stochastic dimension, then the magnitude of offer value ρᵢ₊₁ may be greater than, less than, or equal to, the magnitude of offer value ρᵢ, ρᵢ₊₂, or any other offer value in the sequence of offer values presented to buyer 210 during the subject trading event. A graphical representation of a time-domain mapping of a trading event will be illustrated in FIG. 3, in which seller 205 signals buyer 210 with tuple 225 bearing stochastic offer value ρ 235 and deterministic offer interval δ 230. Graphical representations of trading events in which seller 205 signals buyer 210 with tuple 225 bearing both stochastic offer interval δ 230 and stochastic offer value ρ 235 will be illustrated in FIG. 4 and FIG. 5.

Relative to one embodiment of a preselected trading protocol employed in system 200, buyer 210 may initiate communication with seller 205 through uplink 220 of channel 207, expressing an intention to engage in a mutually beneficial exchange, or a trade. Seller 205 then can signal stochastic decision tuple <δᵢ,ρᵢ> 225 to buyer 210 for evaluation and response. After perceiving the information received from seller 205 in stochastic decision tuple <δᵢ,ρᵢ> 225, buyer 210 can signal seller 205 with response token 240. Typically, buyer can assign preselected response values to response token 240, as described under the preselected trading protocol. For example, response token 240 can be assigned a response value of COMMIT Πᵢ 245, or CANCEL X 250. Desirably, COMMIT response Πᵢ 245 can be linked, for example, using index i, to corresponding offer interval δᵢ 230 and corresponding stochastic offer value ρᵢ 235, to verify that buyer 210 is responding to the present values, which also can be linked, for example, using index i. Conveniently, NULL response Ø 255 can cause a default value of REJECT to be assigned to token 240. Thus, by not responding within a period described by the preselected trading protocol (typically, the offer interval δᵢ), seller 205 may assume that buyer 205 declined, or rejected, the offer to trade during the i^{th} offer interval δᵢ, at the i^{th} offer value ρᵢ. Desirably, the preselected trading protocol instructs buyer 210 to make an affirmative act, in order to signal seller 205. For example, with a COMMIT Πᵢ response 245 being assigned to token 240, buyer 210 makes a commitment to seller 205, during offer interval δᵢ, to exchange for the preselected trade object, an in the amount of DME equivalent to offer value ρᵢ, by which commitment a transaction is made. Also, seller 205 may permit buyer 210 to issue a CANCEL X response 250, by which a made transaction subsequently is repudiated. In this particular embodiment, both COMMIT Πᵢ or CANCEL X responses are accomplished by affirmative steps of buyer 210, which can lessen the likelihood of spurious transactions. Unless buyer 210 disconnects from uplink 220, the trade object inventory is exhausted, or trade interval Δ_{N} has elapsed, seller 205 can be disposed to signal another stochastic decision tuple <δᵢ₊₁,ρᵢ₊₁> 225 to buyer 210. Although trading interval Δ_{N}, may be predefined, it also may be determinable by a seller. Of course, a buyer may terminate involvement in a trade by discontinuing involvement in the trade. Trade will continue if other buyers are participating in the trade, and sufficient inventory is available.

To seller 205, the preselected trading protocol includes signaling buyer 210 with stochastic decision tuple <δᵢ,ρᵢ> 225, waiting for a predefined decision period, e.g., offer interval δᵢ, the receipt of response token 240 from buyer 210. Thus, a simple model of transaction communication in system 200 is one of query between seller 205 and buyer 210 over downlink 215, and response between buyer 210 and seller 205 over uplink 220. In this model, a query may be in the form of tuple 225 and a response may be in the form of token 240.

If, during offer interval δᵢ, buyer 210 signals seller 205 with token 240 bearing COMMIT value 245, then seller 205 makes the transaction with buyer 210. If, after making the transaction, buyer 210 signals with token 240 bearing CANCEL X, then seller 205 cancels the transaction with buyer 210. Unless the trading event has ended, seller 205 can repeat the query by signaling buyer 210 with next stochastic decision tuple <δᵢ₊₁,ρᵢ₊₁> 225. Alternately, to avoid the costs of canceling a made transaction, seller 205 may defer finalization of transactions (making and canceling) until the close of the trading event. However, from the perspective of the buyer, issuing a COMMIT response token 240 to seller 205 may be regarded as a non-contingent transaction, cancelable at the discretion of seller 205, and not as a matter of protocol, as with other classes of transactions, such as auctions or speculation buys. In other words, by communicating a COMMIT response token 240, the buyer affirms a willingness to accept the offered trade object during the selected offer interval. It may be beneficial to seller 205 to permit buyer 210 to freely cancel a transaction, however, due to the higher costs related to returned orders, refunds, credit card transaction corrections, restocking, and so on. Therefore, buyer 210 may be provided a mechanism, e.g., a CANCEL,.X, by which buyer 210 may rescind an accepted offer, before the completion of the respective trading event.

From the perspective of buyer 210, one embodiment of a preselected trade protocol can include connecting with seller 205 via uplink 220 and request access to a predefined trading event for a preselected trade object. If access is granted, buyer 210 is queried by stochastic decision tuple <δᵢ,ρᵢ> 225 from seller 205. By perceiving the information in stochastic decision tuple <δᵢ,ρᵢ> 225, buyer 210 understands that the preselected trade object can be obtained at offer value ρᵢ, with the offer being valid only for the remaining duration of offer interval δᵢ. If buyer 210 elects not to make the transaction under those terms, perhaps with the hope that a future offer value, such as offer value ρᵢ₊₁ will be less than offer value ρᵢ, perhaps significantly less, then buyer 205 will allow offer interval δᵢ to elapse without action. Of course, due to the stochastic nature of at least one dimension (here, ρᵢ) of tuple 225, the magnitude of future offer value ρᵢ₊₁ may be greater than, equal to, or less than, the magnitude of current offer value ρᵢ. By not responding to seller 205 within offer interval δᵢ, buyer 210 has constructively rejected the offer from seller 205 to make a trade for the preselected trade object at offer value ρᵢ.

Upon, or shortly before, the expiration of offer interval δᵢ, but before the end of trading interval Δ_{N}, buyer 210 can be queried again by receiving stochastic decision tuple <δᵢ₊₁,ρᵢ₊₁> 225 for evaluation and response. Should buyer 210 elect to make a trade for the trade object subject to the trading event—at offer value ρᵢ₊₁, it is desirable that buyer 210 assign a value of COMMIT Πᵢ₊₁ 245 to token 240 and respond with token 240 so that it is received by seller 205, before the expiration of offer interval δᵢ₊₁. Upon receipt of the COMMIT Πᵢ₊₁ 245 response from buyer 210, seller 205 can proceed to make the requested transaction, using offer value of ρᵢ₊₁ 235 as the trading price. Should buyer 210 hesitate in taking the present offer of seller 205, and seller 205 does not receive token 240, bearing the COMMIT response Πᵢ₊₁ 245, before offer interval δᵢ₊₁ elapses, the effect can be that of NULL Ø response 255, i.e., a default REJECT response. If buyer 210, after making a trade with seller 205 during offer interval δᵢ₊₁, decides that continuing with the transaction is undesirable, buyer 210 may signal with response token 240 bearing a CANCEL value X. Although trading interval Δ_{N}, may be predefined, it also may be determinable by a seller. Of course, a buyer may terminate involvement in a trade by discontinuing involvement in the trade. Trade will continue if other buyers are participating in the trade, and sufficient inventory is available.

To illustrate the expressed operational principles therein, FIG. 3, FIG. 4, and FIG. 5, make appropriate reference to aspects of system 200 in FIG. 2. Nevertheless, neither system 200, nor the expressed operational principles illustrated through reference to FIGS. 3-5 should be taken to be so limited. The principles thus exposited, and implied, also are generally in accord with principles corresponding to the function and operation of generalized transaction system 100 in FIG. 1.

FIG. 3 is a mapping representative of possible outcomes of stochastic dimension process (generally at 300), which may be used to generate stochastic decision tuple sequence <δ,ρ>. For clarity, the mapping of process 300 is two-dimensional, within the time domain (x-axis) and a “price” range (γ-axis). That is, each element of a sequence corresponds to a two-dimensional characteristic, respectively, a position in time and an assigned value of a defined medium of exchange, typically a monetary value. Accordingly, the x-axis of the mapping depicts trading interval Δ_{N} 315 for a defined trading event. Trading interval Δ_{N} 315 is described by offer interval sequence δ, specifically by constituent offer intervals δ₁, δ₂, . . . , δ_{N}. Although trading interval Δ_{N}, may be predefined, it also may be determinable by a seller. Of course, a buyer may terminate involvement in a trade by discontinuing involvement in the trade. Trade will continue if other buyers are participating in the trade, and sufficient inventory is available. Similarly, the y-axis of the process mapping depicts the range of offer value sequence ρ, including constituent offer values, ρ₁, ρ₂, . . . , ρ_{N}. Each randomized offer value ρᵢ respectively and uniquely corresponds to an offer interval δᵢ having the same i^{th} index value (where i=1 to N).

Trading interval Δ_{N} 315 begins at t₀ 305 and may run until t_{N} 310 such that the maximum time allocated for trading interval Δ_{N} 315 is symbolized by:
Δ_{N}=t_{N}−t₀
As discussed with respect to FIG. 1, above, the maximum time allocated for trading interval Δ_{N} 315 also may be expressed as the sum of the constituent offer intervals δ₁, δ₂, . . . , δ_{N}. That is:

$${Δ}_{N} = {\sum }_{i = 1}^{N} {\partial }_{i}$$

Trading event interval Δ_{N} makes reference to a “maximum” time although, in practice, a predefined trading event may terminate before this maximum time span is reached. A trading event also may be extended, at the discretion of the seller. With the predefined trading event beginning at t₀ 305, the first offer interval δ₁, 320 is defined to span interval t₀ to t₁, second offer interval δ₂ 325 is defined to span interval t₁ to t₂, and so on, up to N^{th} offer interval δ_{N} 330, which is defined to span interval t_{N-1} to t_{N}. In FIG. 3, offer intervals δᵢ are illustrated to be deterministic in time domain. In this example, offer intervals δᵢ generally are of the same duration. As will be seen with respect to FIG. 4 and FIG. 5, the duration of offer intervals δᵢ also may be stochastic. Therefore, both deterministic and non-deterministic domain values, e.g., offer intervals δᵢ, are within the scope of the present invention.

Turning now to the description of range dimension ρ, a sequence of stochastic offer values ρᵢ can be generated by a preselected non-deterministic process, such as one of many, well-known pseudo-random number generators (PRNG), so that the sequence generally does not exhibit a determinable pattern over time. Advantageously, offer values ρᵢ may be defined to vary between a preselected floor value └α┘ 330 and a preselected ceiling value ┌ω┐ 335. Furthermore, offer values ρᵢ can be generated to lie within a preselected distribution envelope, with a mean value μ 340. In the context of FIG. 2, seller 205 may generate the <δ,ρ> dimensions of stochastic decision tuple 225, using preselected non-deterministic process 300, either prior to, or during (“on-the-fly”), a trading event. In certain embodiments, preselected floor value └α┘ 330 can correspond to the lowest offer values ρᵢ that a seller is willing to accept for a particular trade object, during a particular trading event. For example, preselected floor value └α┘ 330 may reflect a seller's cost-to-market price for the preselected trade object subject to the trading event. Similarly, preselected ceiling value ┌ω┐ 335 can correspond to the highest offer value ρᵢ that a buyer may be willing to pay for a particular trade object, during a particular trading event. Again, by example, preselected ceiling value ┌ω┐ 335 may reflect an identified maximum market value (e.g., manufacturer's suggested retail price) for the preselected trade object subject to the trading event. In addition, mean value μ 340 can correspond to the target price that seller 205 assigns to the preselected trade object. This target price may reflect an acceptable gain or margin that the seller may expect to extract, on average, from the buyers as a result of trading event transactions. Although preselected ceiling value ┌ω┐ 335, preselected floor value └α┘ 330, and mean value μ 340 may generally characterize the expected outcomes from process 300, it may be beneficial to shape, or weight, the distribution of offer values ρᵢ, such that the variance of offer values ρᵢ may increase, decrease, or be shifted to a range closer to preselected ceiling value ┌ω┐ 335, or preselected floor value └α┘ 330. As a result, the initial mean value μ 340 expectation may be varied, as well, for example, to reflect market conditions and to modify a present buyer response.

Process 300 is disposed to generate a particular offer value ρ for a corresponding interval δ. Broadly stated, two significant components of stochastic process generation include a pseudo-random number generation (PRNG) technique and the selected probability distribution function [symbol] (x). In general, the PRNG device or technique generates randomized values corresponding to a dimension; the selected probability distribution function [symbol] (x) can be used to shape the distribution envelope of the PRNG output. The dimension can be randomized PRNG outcomes that are assigned as offer values ρ. A distribution envelope corresponding to [symbol] (x) describes general bounds of the sample space within which a sequence of offer values ρ are generated, as well as the spatial position within the dimension, or value assigned to one sample relative to another. It is desirable to use a PRNG device or technique that does not exhibit an undesired value bias; does not demonstrate a unique, short-term “signature” sequence; or is not susceptible to identification through prolonged observations. These are well known in the sciences, engineering, and applied mathematics arts, and will not be elaborated. By carefully selecting a probability distribution function [symbol] (x) to cooperate with a PRNG, the randomized values produced can be substantially within a definable subspace of possible PRNG outcomes. Moreover, the definable subspace of [symbol] (x) outcomes can be shaped so that the values resulting from the outcomes can be generally distributed within a preselected distribution envelope. For example, preselected stochastic process 300 may generate random portions of a dimension according to a normal, or Gaussian, probability distribution, which tends to produce random portions in a range described by the familiar “bell curve”-shaped distribution envelope, relative to a preselected mean value μ 340. Where preselected stochastic process 300 employs a uniform probability distribution to produce a randomized portion of a dimension, the random portion tends to be distributed within a rectilinear, e.g., generally square or rectangular, distribution envelope, relative to the preselected mean value μ 340. Similarly, preselected stochastic process 300 can be selectively adapted with a myriad of other probability distributions, well-known by ordinary practitioners. These distributions can be weighted, skewed, multimodal, or composites of other probability distributions. Non-limiting examples of probability distributions that may be used include, alone or in combination, Cauchy, Cosine, Double Gamma, Laplace, and Student's-t distributions, as well as Beta, Burr, Chi, Fisk, Log Normal, and Triangular distributions. A distribution envelope may be approximated by preselected ceiling value ┌ω┐ 335 and preselected floor value └α┘ 330, respectively. However, it may be advantageous to approximate upper and lower boundary regions by range values that may be approximated by functions other than by preselected ceiling value ┌ω┐ 335 and preselected floor value └α┘ 330, respectively. In addition to receiving the above treatment, an offer value ρ, or sequence of offer values ρᵢ, may be scaled, normalized, or be otherwise dimensionally adapted to the desired range of offer values ρᵢ. As used herein, one or both of floor value └α┘ 330 and ceiling value ┌ω┐ 335 also may have a flexible magnitude responsive to an adaptive process.

Returning to FIG. 3, first stochastic decision tuple <δ₁,ρ₁> is an initial transaction query that signals the beginning of trade interval Δ_{N} 315 at t₀ 305. First stochastic decision tuple <δ₁,ρ₁> generally indicates that, for the duration of first offer interval δ₁ 320, i.e., from t₀ to t₁, a preselected trade object made be traded (e.g., purchased) for the amount described by first trade value ρᵢ 345. However, the offer at first value ρ₁ 345 is time-limited—unless the buyer signals a commitment to trade at trade value ρ₁ 345 before the expiration of trading interval δ₁ 320, the offer will be revoked at t₁. At t₁, the dimensions associated with second stochastic decision tuple <δ₂,ρ₂>are in force. That is, for the duration of second offer interval δ₂, i.e., from t₁ to t₂, the preselected trade object made be traded for the amount described by second trade value ρ₂ 350. As with first trade value ρ₁ 345, the offer to trade at second offer value ρ₂ 350 is limited to the duration of second offer interval δ₂. Provided the trading event is not terminated, an unanswered seller query with stochastic decision tuple <δₖ,ρₖ> evokes a subsequent query with stochastic decision tuple <δₖ₊₁,ρₖ₊₁>, with repeated querying continuing until the values of the last stochastic decision tuple <δ_{N},ρ_{N}>become effective at t_{N-1}. The duration of final offer interval δ_{N} 330 begins at about t_{N-1} and continues until t_{N} 310, at which time, event interval Δ_{N} 315 expires, typically bringing the corresponding trading event to an end. During final offer interval δ_{N} 330, final offer value ρ_{N} 355 is considered to be valid. Upon completion of the N^{th} offer interval of event interval Δ_{N} 315, final offer value ρ_{N} 355 also is revoked, any unconcealed, committed transactions can be cleared. If necessary, logistics and financial arrangements can be made for finalizing the transaction at the agreed offer value ρₖ and for transferring the selected trade object to the buyer.

Selected embodiments also provide seller 205 with the ability to interject promotional offer value pp for the duration of a selected offer interval, here, offer interval δ₈. As with other offer values, it may be advantageous to prepare promotional token <δₖ,ρ_{P}>in advance of the k^{th} period in which it will be used, for example, prior to the trading event commences(i.e., before t₀), or on-the-fly, during the trading event. Promotional offer value ρₚ may be a desirable inducement for potential new buyers to join the selected trading event, or for participating buyers to gain a heightened sense of excitement and entertainment while awaiting from seller 205, a potential transaction query having promotional token <δₖ,ρₚ>. Promotional token <δₖ,ρₚ>may be provided with a shorter offer interval δₖ than is provided otherwise. Typically, desirable response behaviors, which are induced in buyer 210 by promotional token <δₖ,ρₚ>may include intended desirable perturbations, including surprise and excitement; more pragmatically, induced behaviors further may include motivating buyer 210 to commit to the transaction proposed by ρₚ, as well as a sense of urgency, for example, to decide whether to COMMIT to the promotional offer, and to do so before promotional offer interval δₖ expires. In a commercial implementation, promotional offer value ρₚ may be, for example, an offer value substantially below seller cost; a premium or promotional benefit such as free merchandise, services, and the like; and a combination thereof. In other implementations, promotional offer value ρₚ may represent a limited opportunity to obtain enhanced priority, services, or both; as well as a large perturbation, intended to motivate the perturbed party to respond in an intended manner, desired by the party signaling the perturbation.

In certain selected embodiments, more than one promotional offer value ρₚ may be provided, seriatim. In certain other selected embodiments, promotional offer value ρₚ, can be derived using a preselected Transaction Driver function Z that influences offer value ρₚ according to a predefined dimensional relationship. The predefined dimensional relationship generally is a function of one or more trade dimensions. The predefined dimensional relationship may be multifactored, with the constituent dimensional factors be combined linearly, non-linearly, or a combination thereof. For example, Transaction Driver function Z can be defined in terms of trade-dimension-related values, such as trade period interval δₜ, trade inventory interval, δ_{q}, trade object cost difference, δ_{c}, trade margin value δₘ, or, at least one trade indicator or trade dimension, or more if in combination, as may be generally represented by Operational function δₓ. Trade object price ρᵢ can be influenced or determined by Transaction Driver function Z, for example:
ρ_{f}∝ρₚ+∂ₘ(∂ₓ−Z)

That is, the trade price ρ_{f} at which a trade object is offered for sale is generally proportional to a promotional price ρₚ as modified by the influence of Transaction Driver function Z, for example, on a margin variable δₘ. In selected embodiments, Transaction Driver function Z can be a thresholding function, which can appear as an unexpected price drop, thereby inducing the desired consumer behavior.

FIG. 4 also is a mapping representative of possible outcomes of stochastic dimensioning process (generally at 400), which may be used to generate stochastic decision tuple sequence <δ,ρ>. For clarity, the mapping of process 400 is two-dimensional, within the time domain (x-axis) and a “price” range (y-axis). That is, each element of a sequence corresponds to a two-dimensional characteristic, respectively, a position in time and an assigned value of a defined medium of exchange, typically a monetary value. Accordingly, the x-axis of the mapping depicts trading interval Δ_{N} 415 for a defined trading event. Trading interval Δ_{N} 415 is described by offer interval sequence δ, specifically by constituent offer intervals δ₁, δ₂, . . . , δ_{N}. Similarly, the y-axis of the process mapping depicts the range of offer value sequence ρ, including constituent offer values, ρ₁, ρ₂, . . . , ρ_{N}. Similar to FIG. 3, offer values ρᵢ can vary randomly in nature. By carefully selecting a probability distribution function [symbol] (x) to shape the randomized range of values output by a PRNG, a definable subspace of possible PRNG outcomes generally may be approximated by a preselected distribution envelope described by probability distribution function [symbol] (x).

Unlike FIG. 3, in which offer intervals δᵢ are depicted as having a generally uniform duration, offer intervals δᵢ of FIG. 4 are stochastic in nature. That is, the duration of selected offer intervals δᵢ may vary substantially randomly. Conveniently, probability distribution function [symbol] (x) may be used to generate both offer values ρᵢ and offer intervals δᵢ. However, the domain of values over which offer intervals δᵢ run may be generated instead by probability distribution function [symbol] (x), where ( [symbol] (x) ≠ [symbol] (x)). Desirably, each randomized offer value ρᵢ can respectively, and may uniquely, correspond to an offer interval δᵢ having the same i^{th} index value (where i=1 to N).

A trading event, within the context of process 400, may transpire over trading interval Δ_{N} 402, which may run from t₀ 405 to t_{N} 407. Although trading interval Δ_{N}, may be predefined, it also may be determinable by a seller. Of course, a buyer may terminate involvement in a trade by discontinuing involvement in the trade. Trade will continue if other buyers are participating in the trade, and sufficient inventory is available. First offer interval δ₁ 403 may run between t₀ 405 and t₁, corresponding to first offer value ρ₁ 430. Second offer interval δ₂ 404 may run between t₁ 405 and t₂, corresponding to second offer value ρ₂ 440. Offer intervals may be further divided logically, such that final offer period δ_{N} 495, may run between about t_{N-1} and t_{N} 407, and may correspond to final offer value ρ_{N} 455. A trading event also may be terminated before the entire trading interval 402 elapses, or may be extended, for example, at the discretion of seller 205. Because of their stochastic nature, selected ones of offer intervals δ₁, δ₂, . . . , δ_{N} may have durations longer than, shorter than, or of approximately the same duration as, selected other offer intervals δ₁, δ₂, . . . , δ_{N}. The selected duration of an offer interval δᵢ, can be generated by probability distribution function [symbol] (x) to vary generally between predetermined minimum offer interval δ_{L} 485 and predetermined maximum offer interval δᵤ 490. Probability distribution function [symbol] (x) can be selected such that the corresponding distribution envelope of the offer interval δᵢ substantially conforms to the sample subspace desired.

In selected embodiments of the present invention, one or more offer intervals δ₁, δ₂, . . . , δ_{N} occurring during trading interval Δ_{N} 402, may not be stochastic in nature, but be deterministic, for example, defined by a dimension other than time, such as allocated inventory. In the example of allocated inventory, a deterministic interval offer interval δ_{f} terminates upon exhaustion of the allocated inventory or, more generally, upon a condition established by other, non-temporal dimensions. The entire temporal component of trading interval Δ_{N} 402 may be considered to be generally non-deterministic, even if a deterministic offer interval δ_{f} is interposed therein. Similarly, offer value ρₚ, also may be, at least in part, deterministic, and also may be established to correspond to a trading dimension, including, without limitation, existing or allocated inventory, product type, and so forth.

Similar to stochastic process 300 in FIG. 3, two-dimensional non-deterministic process 400 in FIG. 4 can implement one or more well-known PRNG devices and techniques (PRNG), in one or more dimensions, to generate sequences of stochastic offer values ρᵢ and stochastic offer intervals δᵢ. Corresponding respective probability distribution functions, [symbol] (x) and [symbol] (x), may be preselected to cooperate with the. PRNG so that the randomized values produced thereby can be substantially within a definable subspace of possible PRNG outcomes. Also, preselected stochastic process 400 can be chosen from among one or more of a wide array of weighted, skewed, multimodal, or composite, probability distributions, with each distribution typically being dispersed around a preselected mean value. In FIG. 3, stochastic offer values ρᵢ may vary between a preselected floor value └α┘ 330 and a preselected ceiling value ┌ω┐ 335, within a preselected distribution envelope dispersed about mean value μ 340. Likewise, the stochastic offer values ρᵢ in FIG. 4 may vary between a preselected floor value └α┘ 415 and a preselected ceiling value ┌ω┐ 425, within a preselected distribution envelope dispersed about mean offer value μ 445. Offer intervals δᵢ may vary between predetermined minimum offer interval δ_{L} 485 and predetermined maximum offer interval δᵤ 490, within a preselected distribution envelope, which may be distributed about some mean interval value (not shown). Non-limiting examples of probability distributions that may be used include, alone or in combination, Uniform, Gaussian, Cauchy, Cosine, Double Gamma, Laplace, and Student's-t distributions, as well as Beta, Burr, Chi, Fisk, Log Normal, and Triangular continuous distributions, as well the gamut of suitably chosen discrete distributions.

Unlike process 300 in FIG. 3, embodiments according to process 400 in FIG. 4 may possess an adapted mean value μ 445, which may result from implementation of adapted upper target offer value ξ 430 and adapted lower target offer value β 420. It may be desirable to adapt one or both of value ξ 430 and value β 420 in response to factors of the environment in which the trading event occurs. Where transactions described herein are within a commercial context, environment factors can include trade object supply side environment factors (e.g., availability of trade objects from a supplier), trade object demand side environment factors (e.g., demand trends among consumers), as well as other environment factors including, without limitation, fluctuations in overhead expenses; changes in finance, energy and transport costs; geopolitical factors; and so on). The adapted trade range between upper value ξ 430 and lower value β 420 also may be indicative of a range of offer values ρᵢ, which has been determined, such as by seller 205 in FIG. 2, to be representative of a range in which buyer 210 is more likely to COMMIT to a transaction. In general, an increase in one or a paired increase in both of adapted lower target offer value β 420 and adapted upper target offer value ξ 430, may result in an increase in mean value μ 445.

Should preselected floor value └α┘ 415 generally correspond to, for example, the cost-to-market to seller 205 for a trade object, the effect of raising selected lower target offer value β 420 can be to increase the margin of seller 205. By contrast, a decrease in one or a paired decrease by both of adapted lower target offer value β 420 and adapted upper target offer value ξ 430, may result in a decrease in adapted mean value μ 445. This reflects a tendency for a transaction to bring a lower offer value ρᵢ for a given trade object. Should preselected floor value └α┘ 415 be representative of the cost-to-market to seller 205 for a trade object, the aforementioned tendency to decrease adapted mean value μ 445 generally reflects a tendency for buyer 210 to make a transaction for a trade object at a savings and a tendency for seller 205 to yield a lower margin from the transaction.

Of course, a trend towards a lower price for a trade object, typically results in a trend for additional transactions for the object, which may be desirable for seller 205. Advantageously, adapted lower target offer value β 420 and adapted upper target offer value ξ 430 can cooperate such that stochastic offer values ρᵢ may vary between adapted lower target offer value β 420 and adapted upper target offer value ξ 430, within a preselected distribution envelope dispersed about adapted mean value μ 445. Importantly, adapted lower target offer value β 420 and adapted upper target offer value ξ 430 may be so adapted before, during, or after a trading event. For an example during a trading event, if seller 205 notices a reluctance to transact on the part of buyer 210, seller 205 may reduce one or both of adapted lower target offer value β 420 and adapted upper target offer value ξ 430 to result in a decreasing trend in adapted mean value μ 445. Thus, although buyer 210 may still perceive one or both of offer intervals δᵢ and offer values ρᵢ as being generally stochastic, the distribution envelope characterizing offer values ρᵢ may be perceived as tending lower, thereby tending to induce buyer 210 to COMMIT to make a transaction. Not only may adapted lower target offer value β 420 and adapted upper target offer value ξ 430 be adapted dynamically (on-the-fly), for example, to shift adapted mean value μ 445 higher or lower, the distribution envelope corresponding to the values produced for process 400 also may be adapted.

For example, it may be desirable to reduce (or increase) adapted mean value μ 445, as well as to adapt distribution function [symbol] (x) such that offer values ρᵢ are generated within an exemplary Gaussian distribution envelope instead of an exemplary Uniform distribution. Therefore, embodiments of the present invention provide methods and apparatus offering flexibility in generation of the stochastic characteristics of a trade object, as perceived by an engaged transactor. Flexibility in the dimension of offer values ρᵢ can be complemented by flexibility in the dimension of offer intervals δᵢ. That is, embodiments of the present invention provide methods and apparatus offering flexibility in generation of the stochastic characteristics of a trade event, as perceived by an engaged transactor. For example, it may be desirable to reduce (or increase) a mean value for offer interval δᵢ, as well as to adapt distribution function [symbol] (x) such that offer intervals δᵢ are generated within an exemplary Gaussian distribution envelope instead of an exemplary Uniform distribution. Distribution function [symbol] (x) may be adapted further such that offer intervals δᵢ can at least weakly correspond to offer values ρᵢ. For example, it may be desirable to generate a distribution envelope for offer intervals δᵢ such that offer intervals δᵢ tend to be shorter when offer values ρᵢ approach the extrema of the distribution envelope representative of distribution function [symbol] (x), and that offer intervals δᵢ are generally longer for offer values ρᵢ tending toward the mean value μ 445, representative of function [symbol] (x). However, another result, and another correspondence, between offer intervals δᵢ and offer values ρᵢ may be desired. Nevertheless, according to the teaching herein, methods and apparatus so adapted readily may achieved a desired result and a target correspondence.

FIG. 5 is yet another mapping, representative of possible outcomes of plural stochastic dimension process ensemble (generally at 500), which may be used to generate stochastic decision tuple sequences <δ,ρ>. However, unlike FIG. 4, in which each dimension (δᵢ,ρᵢ) can be drawn from one process, sequences representative of each dimension (δᵢ,ρᵢ) may be generated using multiple, disparate stochastic processes and drawn from multiple, disparate, distribution envelopes, yet be adaptably and controllably generated within a desired space. Stochastic process 500 may be constructed from plural subprocesses, in a building-block fashion. Such a composite process can generate controllable, deterministic outcomes that can be used to form one or more stochastic dimension sequences. The selected subprocesses of the composite stochastic process also may be stochastic in nature, and adapted to yield selected dimension portions, which generally may lie within a definable subspace. As with previously recited stochastic values, the values generated by process 500, are adapted to induce a desired behavior in a selected perceiver, such as, for example, second transactor 120, in FIG. 1, or buyer 210 in FIG. 2. The adapted values generated by process 500 may include one or both of stochastic offer value ρᵢ and stochastic offer interval δᵢ.

Stochastic offer intervals δᵢ may vary between adapted minimum offer interval δ_{L} 585 and adapted maximum offer interval δᵤ 590, within a preselected distribution envelope, and which may be distributed about some mean interval value (not shown). Likewise, stochastic offer values ρᵢ may vary between a preselected floor value └α┘ 515 and a preselected ceiling value ┌ω┐ 525, dispersed about adapted mean offer value μ 545, within a preselected distribution envelope. Adapted mean value μ 545 may result from implementation of adapted upper target offer value ξ 530 and adapted lower target offer value β 520, positioned between ┌ω┐ 525 and └α┘ 515. Similar to value ξ 430 and value β 420 in FIG. 4, it may be desirable to adapt one or both of value ξ 530 and value β 520, in response to factors of the environment in which the trading event occurs. Importantly, adapted lower target offer value β 520 and adapted upper target offer value ξ 530 may be so adapted before, during, or after a trading event.

Unlike the process 300 in FIG. 3, or process 400 in FIG. 4, stochastic process 500 in FIG. 5 is a composite process, which represents an ensemble, or defined group, of random processes ξ₁, ξ₂, . . . , ξ_{M}. One or more sequence values <δᵢ,ρᵢ>.may be generated by one or more of the ensemble of random processes ξ₁, ξ₂, . . . , ξ_{M}. Ensemble members ξ₁, ξ₂, . . . , ξ_{M}can be used to generate sequence values in numerous ways. In one exemplary technique, each <δᵢ,ρᵢ> stochastic decision tuple may be generated by corresponding process ξᵢ, which itself may include suitable PRNG to generate values of <δᵢ,ρᵢ> using functions [symbol] (x) and [symbol] (x), respectively. In another exemplary technique, each <δᵢ,ρᵢ> stochastic decision tuple may be generated by a randomly-selected ensemble member ξᵢ, as is illustrated in FIG. 5. In certain embodiments, one ensemble member ξ may be provided for each offer interval δᵢ in trading interval 502. In others, there may be fewer ensemble members ξ than offer intervals δᵢ. In such a case, it is desirable to re-use ensemble member functions ξ, so that member functions ξ may be used multiple times to generate offer interval δᵢ together with offer value ρᵢ. In certain embodiments, it is advantageous to generate stochastic decision tuple <δᵢ,ρᵢ>.in real-time, or near-real-time, as a trading event transpires. In other embodiments, it may be advantageous to generate stochastic decision tuple <δᵢ,ρᵢ> prior to the trading event. As indicated above, by applying a selected distribution function to outcomes generated by a PRNG, the boundaries and shape of the process subspace can be controlled using, for example, mean value, boundary values, and adapted target values as input for the processes of ξ. Such piecewise control of the stochastic process represented by process 500, stochastic decision tuple <δᵢ,ρᵢ> values can be shaped and clustered to adapt to, and to at least weakly correspond with, an external process, which may be transpiring at least partially concurrently with process 500. Such an external process could include, for example, music, live or recorded events, and the like. Thus, according to the teachings herein, stochastic process 500 could provide stochastic decision tuple <δᵢ,ρᵢ> in a manner that allows selected values of <δᵢ,ρᵢ> remain at least stochastic and randomized, yet appear as if they bear some coordination with the external process. As before, non-limiting examples of probability distributions that may be used include, alone or in combination, Uniform, Gaussian, Cauchy, Cosine, Double Gamma, Laplace, and Student's-t distributions, as well as Beta, Burr, Chi, Fisk, Log Normal, and Triangular continuous distributions, as well the gamut of suitably chosen discrete distributions.

Further to FIG. 5, trading interval 502 can begin at t₀ 505 with onset of first offer interval δ₁ 503 and continue until t₁, at which time second offer interval δ₂ 504, begins. Prior to t₀, ensemble member process ξ₅ generates first stochastic decision tuple <δ₁,ρ₁> which can be signaled to a selected perceiver, such as second transactor 102 in FIG. 1 or buyer 210 in FIG. 2. Generally following the signaling protocol described, for example, with respect to FIG. 2, buyer 210 perceives offer value ρ₁ and, if desirous to make a transaction with seller 205, buyer 210 signals a COMMIT response to seller 205 before offer interval 67 ₁ expires. Prior to the expiration of first offer interval δ₁, ensemble member process ξ₃ generates second stochastic decision tuple <δ₂,ρ₂>. Should buyer 210 not respond before the end of first offer interval δ₁, or does not otherwise provide a COMMIT response, second stochastic decision tuple <δ₂,ρ₂> can be signaled to buyer 210 before first offer interval δ₁ expires. At t₁, the trade object, which is available for trading, can be offered by seller 205 to buyer 210 for second offer value ρ₂, with this value being valid for only a period of δ₂ interval 504. Prior to the end of second offer interval δ₂, ensemble member process ξ₈ can generate third stochastic decision tuple <δ₃,ρ₃>, which is signaled to buyer 210 before t₂. In general, the generation of new stochastic decision tuples <δ₁,ρ₁> may repeat throughout trading interval 502, with ensemble member process ξ₄ generating N^{th} decision tuple <δ_{N},ρ_{N}> for use with N^{th} offer interval δ_{N} 595, typically terminating at t_{N} 507. Similar to process 400 in FIG. 4, offer intervals may vary substantially randomly between adapted lower bound offer interval δ_{L} 585, and adapted upper bound offer interval δᵤ 590. In addition, a promotional decision tuple <δ_{P},ρ_{P}> can be signaled to buyer 210 in advance of promotional offer interval δₚ. Promotional decision tuple <δ_{P},ρ_{P}> may be interjected by seller 205 during the transpiration of event interval 502, or may be interjected in advance, for example, during an advanced generation of decision tuples <δ,ρ> while planning for a particular trading event. Offer intervals δᵢ and offer values ρₚ, may selectively be generated and presented, using composite stochastic methods herein, and used within the context of an entertainment schema. For example, in an milieu, the signaling of stochastic decision tuples <δ,ρ> can be coordinated with audio and visual indicia, including music, sounds, dramatic images, and the like, to heighten excitement and interest in a particular trading event. Buyer 210 may be induced into behaving in a desired way, for example, committing to making a trade, for a trade object offered during a trade interval, in response to perceiving the stochastic decision tuples <δ,ρ>. Process 500 may be one of many such transaction processes, which may be proceeding, whether simultaneously or serially, in which it may be desirable for seller 205 to monitor and adjust, as desired, adapted upper target offer value ξ 530 and adapted lower target offer value β 520, which may be common to at least some of these transaction processes In this manner, seller 205 is provided with methods and apparatus to adapt the trading event milieu, such as trade object pricing and trading event pacing, to a desired range. Seller 205 also can be enabled to adapt and adjust profit margin, clearance prices, promotional events, and so on, and to differentiate trade object transactions for selected classes of buyers 210.

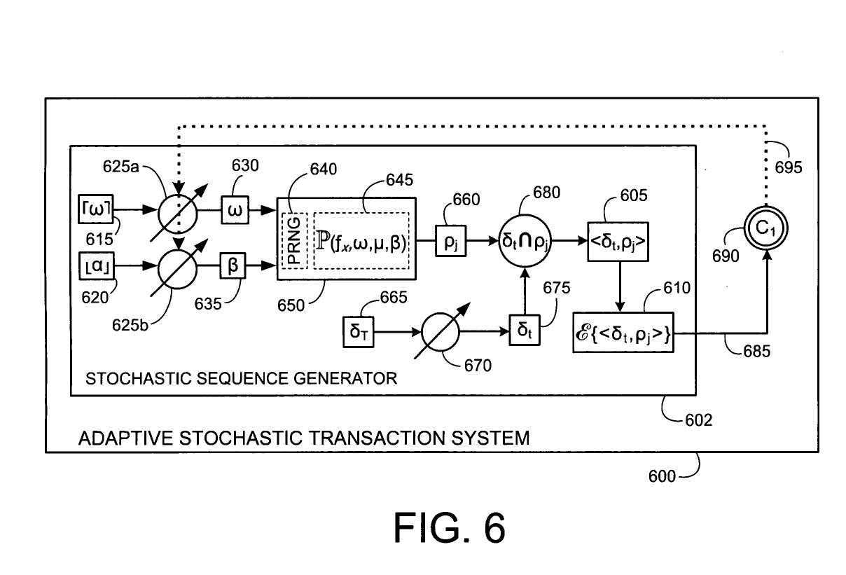

FIGS. 6, 7, and 8 are exemplary embodiments of adaptive stochastic transaction systems, respectively corresponding to the FIG. 3, FIG. 4, and FIG. 5.

FIG. 6 symbolically depicts exemplary stochastic sequence generator 602, as an element of adaptive stochastic transaction system 600. Stochastic sequence generator 602 can be representative of one possible embodiment by which stochastic decision tuple <δₜ,ρᵢ> 605 may be formed. Broadly, stochastic decision tuple <δₜ,ρᵢ> 605 may be signaled, as variable element of stochastic transaction process 610, by way of communication channel 685 to transactor C₁ 690. Desirably, when perceived, stochastic decision tuple <δₜ,ρᵢ> 605 is adapted to induce a desired behavior in transactor C₁ 690. Advantageously, system 600 may use behaviors of one or more transactor C₁ 690, as feedback signal 695, to adapt system 600 (e.g., through output communication path 685) to a behavior of transactor C₁ 690.

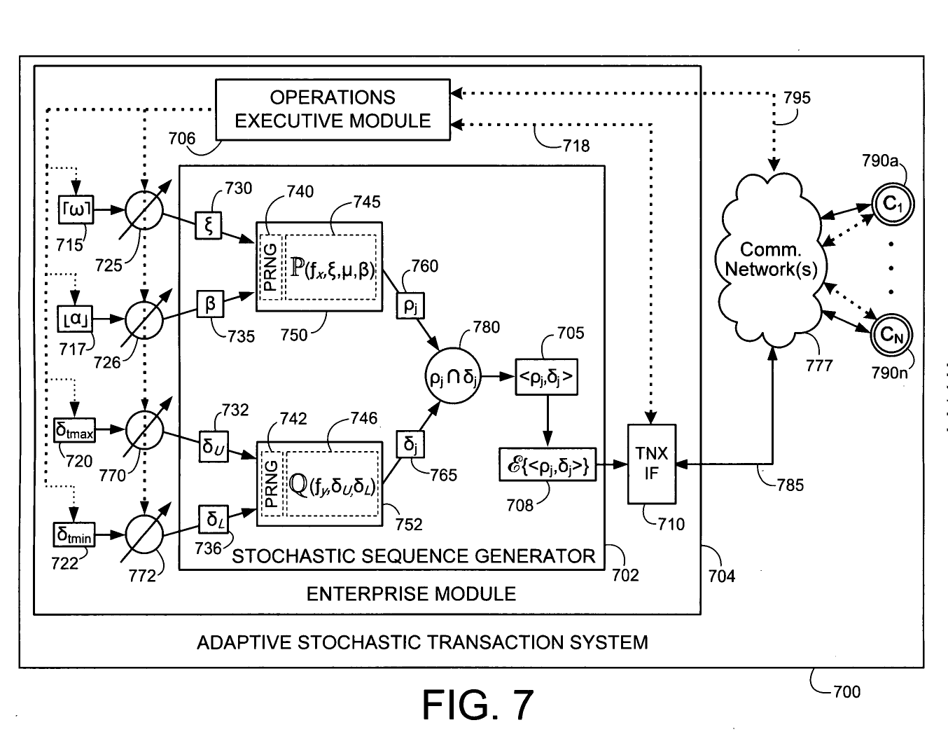

FIG. 7 symbolically depicts adaptive stochastic transaction system 700, as employing one possible embodiment stochastic sequence generator 702 by which the stochastic sequence of process 400 in FIG. 4 may be generated. Stochastic sequence generator 702 can accept variable inputs 725, 726, 770, 772 from enterprise module 704 to produce stochastic decision tuple 705. Within enterprise module 704, upper and lower bounds for offer values ρⱼ can be shaped by ceiling value 715 and floor value 717, respectively. Similarly, offer interval δⱼ can be bounded by maximum offer interval length 720 and minimum offer interval length 722. Each of value bounds 715, 717 and interval bounds 720, 722 may be responsive to enterprise operations feedback from operations executive module 706. Module 706 may monitor operational parameters via command and intelligence links 718, 795. Such operational parameters may include data being transmitted to one or more of transactors C₁ 790a to C_{N} 790n via communication network 777; remote transactional information and control data 795, for example the number of transactors 790a, 790n currently coupled to module 702, the nature and magnitude of the transactions being executed; remote transactor 790a, 790n control responses and geolocations; and channel conditions in network 777, including available bandwidth, throughput, quality of service, latency, and return trip time of probe packets.

Stochastic process generator 750 may produce offer values ρⱼ 760 in response to desired upper and lower offer value guidelines 730, 735 within which offer value ρⱼ 760 can be predominantly distributed. In certain implementations of the present invention, pseudorandom number generator 740 can produce a pseudorandom variable representative of offer value ρⱼ 760 generally within the range represented by value guidelines 730, 735. Stochastic process conditioner 745 may be employed to adjust offer value ρⱼ 760 to generally conform to a predetermined process envelope and stochastic distribution, which may be approximately centered about desired mean offer value μ, responsive to distribution shaping function fₓ. Similarly, stochastic process generator 752 may produce offer interval δⱼ 765 generally within the range represented by interval guidelines 732, 736, as may be limited by interval bounds 720, 722. Pseudorandom number generator 742 can be employed to produce a pseudorandom value generally within the range represented by guidelines 732, 736. As with offer value ρⱼ 760, it may be desirable to provide multiple offer intervals δⱼ 765 that generally conform to a predetermined process envelope and stochastic distribution, responsive to distribution shaping function f_{y}. Tuple generator 780 associates offer value ρⱼ 760 offer intervals δⱼ 765 for a given index j, producing decision tuple <ρⱼ, δⱼ> 705. Each tuple thus produced can be assembled within stochastic ensemble generator 708, to produce a selected sequence of decision tuples <ρⱼ,δⱼ> 705, associated with the trade object offered during the particular trading event at hand. Ensemble generator 708 can be enabled to transmit via enterprise communications module 710 to remote transactors 790a, 790n.

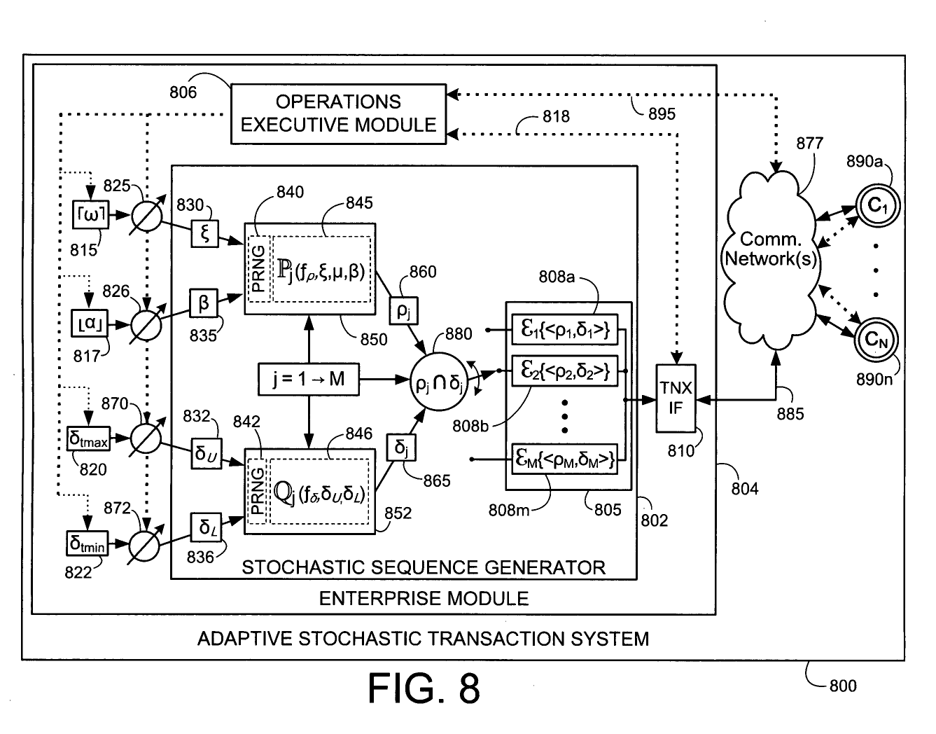

FIG. 8 symbolically depicts adaptive stochastic transaction system 800, as employing one possible embodiment stochastic sequence generator 802 by which the stochastic sequence of process 500 in FIG. 5 may be generated. Stochastic sequence generator 802 can accept variable inputs 825, 826, 870, 872 from enterprise module 704 to produce stochastic decision tuple 805. Within enterprise module 804, upper and lower bounds for offer values ρⱼ can be shaped by ceiling value 715 and floor value 817, respectively. Similarly, offer interval δⱼ can be bounded by maximum offer interval length 820 and minimum offer interval length 822. Each of value bounds 815, 817 and interval bounds 820, 822 may be responsive to enterprise operations feedback from operations executive module 806. Module 806 may monitor operational parameters via command and intelligence links 818, 895. Such operational parameters may include data being transmitted to one or more of transactors C₁ 890a to C_{N} 890n via communication network 777; remote transactional information and control data 895, for example the number of transactors 890a, 890n currently coupled to module 802, the nature and magnitude of the transactions being executed; remote transactor 890a, 890n control responses and geolocations; and channel conditions in network 777, including available bandwidth, throughput, quality of service, latency, and return trip time of probe packets.

Stochastic process generator 850 may produce offer values ρⱼ 860 in response to desired upper and lower offer value guidelines 830, 835 within which offer value ρⱼ 860 can be predominantly distributed. In certain implementations of the present invention, pseudorandom number generator 840 can produce a pseudorandom variable representative of offer value ρⱼ 860 generally within the range represented by value guidelines 830, 835. Stochastic process conditioner 845 may be employed to adjust offer value ρⱼ 860 to generally conform to a predetermined process envelope and stochastic distribution, which may be approximately centered about desired mean offer value μ, responsive to distribution shaping function fₓ. Similarly, stochastic process generator 852 may produce offer interval δⱼ 865 generally within the range represented by interval guidelines 832, 836, as may be limited by interval bounds 820, 822. Pseudorandom number generator 842 can be employed to produce a pseudorandom value generally within the range represented by guidelines 832, 836. As with offer value ρⱼ 860, it may be desirable to provide multiple offer intervals δⱼ 865 that generally conform to a predetermined process envelope and stochastic distribution, responsive to distribution shaping function f_{y}. Tuple generator 880 associates offer value ρⱼ 860 offer intervals δⱼ 865 for a given index j, producing decision tuple <ρⱼ,δⱼ> 805. Each tuple thus produced can be assembled within stochastic ensemble generator 805, to produce a selected sequence of decision tuples <ρⱼ, δⱼ> corresponding to plural sequence ensembles 808a-808m, each ensemble being associated with the trade object offered during the particular trading event at hand.

Tuple sequences associated with respective ensemble 808a-808m may have respective preselected mean values, distribution function envelope, and other process parameters that differ from others of ensembles 808a-808m. Ensemble generator 805 can select tuples from selected one of respective ensemble 808a-808m perhaps in response to real-time feedback from remote transactors 890a, 890n; from profit, loss, inventory, and demographic information provided through module 806; or both. Moreover, given the selectability of the length and characteristics of multiple sequences selectable from generator 805, predictive or anticipatory action to impair the fairness or integrity of system 800 can be minimized, due to the employing multiple processes, generating multiple non-identical ensembles of stochastic decision tuple <δᵢ,ρᵢ>, and intermixing potentially variable sequences of stochastic decision tuple <δᵢ,ρᵢ> drawn from different ensembles and different processes.

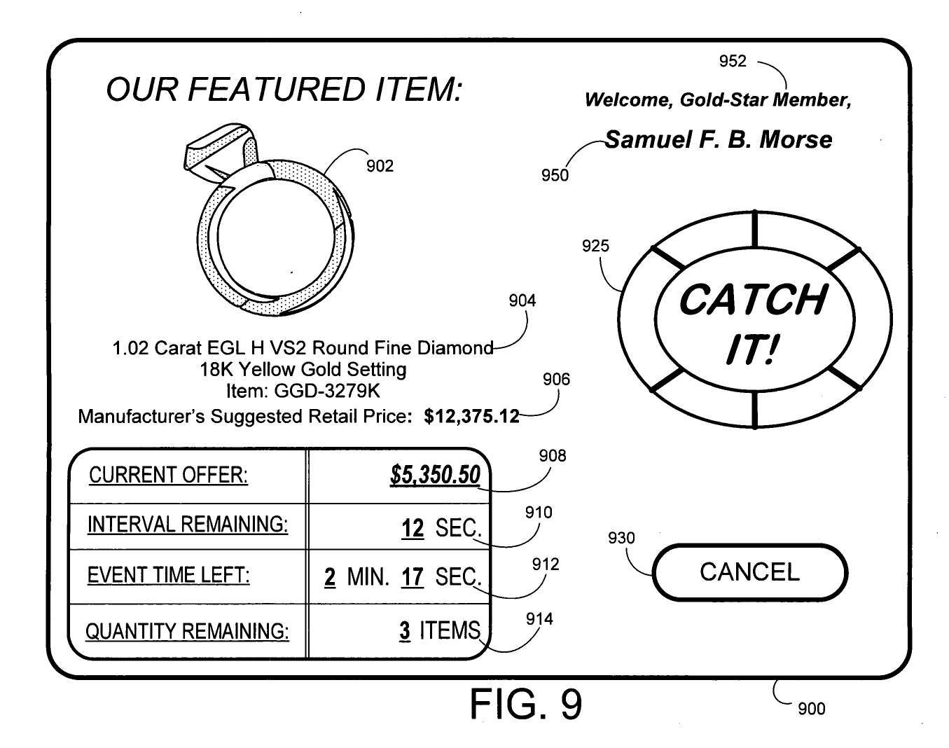

FIG. 9 depicts an embodiment of a graphical user interface (GUI) 900, as may be perceived by a user/buyer (not shown), such as transactor T₂ 120 in FIG. 1, or consumer C 210 in FIG. 2 (generally, “purchaser”). Interface 900 may be useful to illustrate functions and features of selected methods embodied herein. GUI 900 is representative of computer code executing in a computer system used to display information to the purchaser, in the form of descriptors, which may be considered relevant to the purchaser's decision to purchase, or agreement to purchase, a selected trade object during a selected trading event. For example, the descriptors of GUI 900 can indicate to the purchaser: that a transaction is in progress; that trade object 902 is featured during the trading event; that trade object 902 may be purchased at current offer value 908; that current offer value 908 will remain valid during the offer interval 910; that the remaining time for the event 912 represents the remaining period of the trading interval; and that a determinable number of trade objects 914 currently exist in inventory.

GUI 900 can be representative of computer code executing in a computer system to provide additional information, which may be useful to the purchaser in evaluating the beneficial aspects of the transaction may include specific inventory descriptors 904, and a manufacturer's suggested retail price 906, which allow the purchaser to make independent appraisals of the actual value and desirability of trade object 902. Additional descriptors to enhance the personalized trading milieu represented by GUI 900 may include purchaser name or trading identifier 950, and, if implemented, membership and status descriptors 952. A seller also may choose to communicate with the purchaser for other purposes, such as offering payment and shipping information to a credit and order fulfillment entity, which may be part of an enterprise including the seller.

Excitement and drama can be augmented by providing GUI 900 with perceived experience intensifiers which tend to enhance a prospective buyer's desire to purchase the trade object. Exemplary perceived experience intensifiers can include any artifice intended to seize the attention of the prospective purchaser including, without limitation, dramatic tones, melodic notes, or other psychoacoustic stimulations; flashing lights, alternating, or chaotic, patterns of colors, or other distinctive imagery apart from visual presentation elements ordinarily on display; tactile feedback; dramatic fluctuations in offer value 908 and intervals 908, 910; or by any effective combination thereof.

In such implementations, it may be advantageous to configure COMMIT selector 925 as a selector that is easy-to-use during trading events. In that regard, selector 925 can be provided as large, colorful icon, which may provide a colorful visual counterpoint to the background of GUI 900. For example, where selector 925 issues a COMMIT signal by a computer mouse-over-and-click movement, a purchaser may initially position the mouse cursor over selector 925, wait until the trade descriptors 908, 910, 912, 914 reach a desirable point. At the moment of purchase, the buyer can click a mouse button on selector 925 to COMMIT to purchase the trade object represented by descriptor 902 at the offer value represented by descriptor 908. In addition, where GUI 900 is representative of computer code executing in a computer system used by the purchaser, which communicates with the seller, the purchaser may be enabled to terminate a COMMIT to a transaction before the end of the trading event indicated by descriptor 912, by asserting CANCEL selector 930.

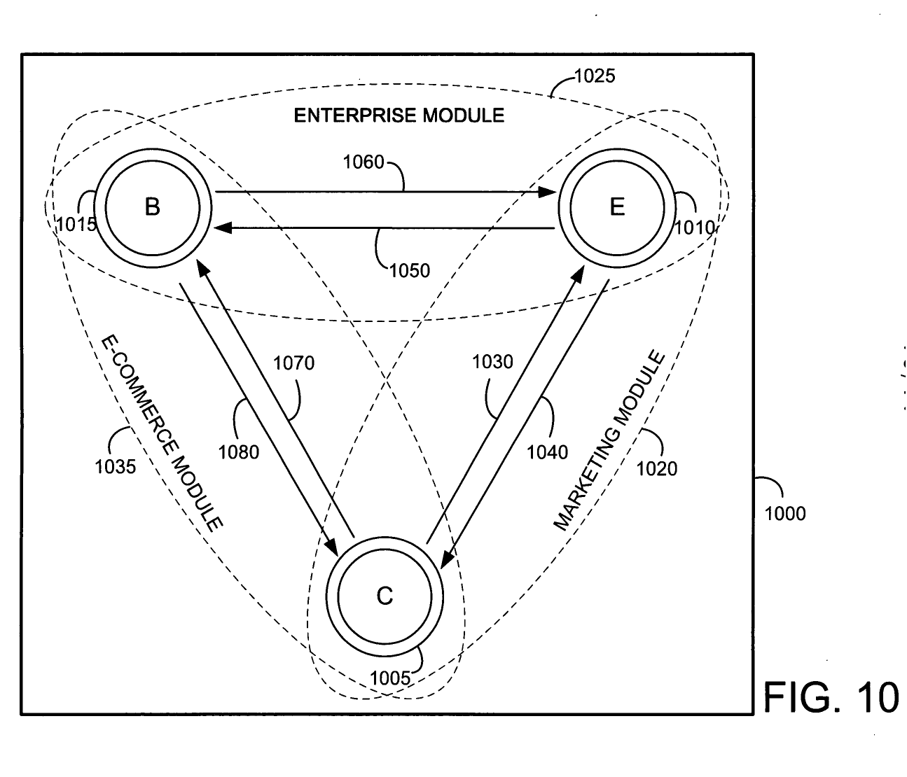

FIG. 10 depicts an embodiment of adaptive stochastic transaction system 1000 that includes marketing module 1020, enterprise module 1025, and e-commerce module 1035. Module 1020 may be similar to system 100 in FIG. 1 and system 200 in FIG. 2, although the function and operation of modules 1020, 1025, 1035 can be viewed as being incorporated into transactor T1 110 in FIG. 1 and seller E 205 in FIG. 2.

In FIG. 10, marketing module 1020 is adapted to enable and facilitate trading events between buyer C 1005 and seller E 1010. A communication route in module 1020 typically includes uplink 1040 and downlink 1030. In general, once it is communicated from seller E 1010 over downlink 1030 and perceived by buyer C 1005, a stochastic decision token ψ (not shown) is disposed to induce an observed behavior in buyer C 1005. Similar to stochastic decision token ψ 160 in FIG. 1 and stochastic decision tuple <δ,ρ> 225 in FIG. 2, et seq., a decision token or tuple transmitted to Buyer C 1005 from seller E 1010 can be representative of at least one of a stochastic offer value and a stochastic offer interval, presently associated with the preselected trade object (not shown), subject to the present transaction. Module 1020 may represent sales and entertainment delivery activities, by which one or more Buyers C 1005, may engage in transactions with Seller E 1010 in a dynamic and exciting transaction milieu via any form of communication. Buyer C 1005 may be able to interact with seller 1010 using nearly any form of electronic media, whether broadcast, multicast, or unicast, over public computer network or wireless broadcasts, whether by phone, personal electronic communicator, computer, or any contemplated communication device. However, it may be advantageous and efficient to separate sales/trading and entertainment operations from those involved with completing transactions and preparing and promoting new transactions.

Accordingly, E-Commerce Module 1035 may include “Back Office” Unit B 1015, which may provide, without limitation, subscription and pre-approval management, credit and payment processing, order fulfillment, warehousing, shipping, purchasing, accounting, executive and operations management, operations research, broadcasting, networking and systems infrastructure, advertising and marketing, econometrics and market analysis, and ombudsman activities. Back Office Unit B 1015 may interact with consumer C 1005, a Buyer, for the purpose of accepting and verifying the payment of Buyer C 1005, for a trade object purchased from Seller E 1010 via Marketing Module 1020. Unit B 1015 also may receive information from Seller E 1010 such as multi-dimensional data collected during trading operations, one example of which may be Seller E 1010 reporting to executives in Unit B 1015 what prices were paid in a given region for a given trade object at a given time. Indeed, whatever business intelligence may be gleaned by Seller E 1010, individually, in the aggregate, or both, can be fed back to Unit B 1015, so that operations of E-Commerce Module 1035, Enterprise Module 1025, or both, may be adapted advantageously thereby.

In return, within the context of the functions and operations of Enterprise Module 1025, Unit B 1015 can apprise Seller E 1010 of current and future trading operations, events, and data, such as price floors and ceilings, desired margins, anticipated, available, and allocated inventories of trade objects, and trading times, and locations in which such trading events will be offered. Beneficially, Unit B 1015 can receive information from customers (such as buyer C 1005), vendors, lenders, creditors, manufacturers, and competitors, as well as other sources of public and proprietary information to permit long-range, intermediate-term, and short-range decisions as to inventory, prices, channels of commerce and communication, target markets, risk and cost allocation, and any other factor that could be used to determine what objects were offered for trade, where and when they are offered, and at what price.

In this regard, embodiments, aspects, and features of marketing module 1020, enterprise module 1025, and e-commerce module 1035, can be devised and coupled to selectively communicate, forming advantageous embodiments of systems and methods for adaptive stochastic transactions. As indicated above, a business operator, such as enterprise module 1025, may use selected trade indicators to adjust an adaptive stochastic transaction process herein to meet desired business objectives and to influence the behavior of the buyer in real-time, near-real-time, periodically, or episodically.

In a case where an undesirable or deleterious trade indicator is measured, a business operator may desire to adapt one aspect of the Transaction Driver function Z to correct or to offset the undesirable indicator. For example, excess prospective buyer activity may be undesirable during a particular trading event, where one objective of the trading event is to increase trade object brand awareness among prospective buyers. Excessive activity in a trading event may quickly deplete the inventory available for the trading event, which, in turn, may terminate the trading event before the trade object receives the desirable amount of viewer exposure. Also, excessive activity can engender in prospective buyers a perception of lesser value of a trade object, and leave in its wake unsatisfied customers. Excessive activity may be indicated by high telephonic call volume or by high network link volume, i.e., too many buyers “just looking.” Erratic responses by groups of prospective buyers also may be representative of an unfavorable trading environment.

In such an example, it may be beneficial to adapt the Transaction Driver function Z such that the offered trade object value or price ρ_{N} trends upward. It is generally recognized that increasing an object's price can decrease buyer demand. Thus, by allowing the offered trade object value ρ_{N} to trend upward as can be generated by a stochastically-influenced transaction process, excessive buyer activity can be curtailed. In another example, a business operator may measure a number of network links or telephonic connections that appears disproportionately large compared to the contemporaneous sales volume, and possibly, by other prior measures and trade indicators. This may suggest that a trade object offer value ρ_{N} is considered by observant prospective buyers as being too high. Responsive to such indicators, a business operator may bias the Transaction Driver function Z to increase, thereby reducing the price ρ_{N} at which the trade object is offered to prospective buyers. As the price tends to drift stochastically lower, an increase in sales volume may be measured as prospective buyers are induced to transmit a COMMIT token, or functional equivalent thereof, to the seller, and become actual buyers.

Also, selected trade indicators may be combined to adapt the Operational function δₓ to a vast variety of trade indicators and measurements of influences both internal to and external to the enterprise. It can be advantageous to selectively combine trade indicators, so that the Operational function δₓ includes a short term weighting factor, intermediate weighting factor, long term weighting factor, or a combination thereof. Short-term weighting factors can be representative of selected trade indicator responding to activities or events of relatively short duration, for instance excess buyer activity during a trading event. An intermediate weighting factor may be derived from a selected trade indicator representative of factors such as fuel costs and energy surcharges which may impact an enterprise through higher operating expenses and trade object purchasing costs over a time longer than short-term factors. A long-term weighting factor may be adapted to reflect strategic goals of the corporation, or regional or demographic factors, and the like.

Although the exemplars set forth in the foregoing Figures illustrate temporally-adapting processes and corresponding apparatus, neither the range nor the domain of inventive adaptive stochastic transaction embodiments herein are limited to one particular dimension but, instead, may be defined over plural dimensions, possibly exclusive of the time domain. Applicable dimensions may include aforementioned trade dimensions, such as those influenced by consumer, market, competitor, or enterprise measures.

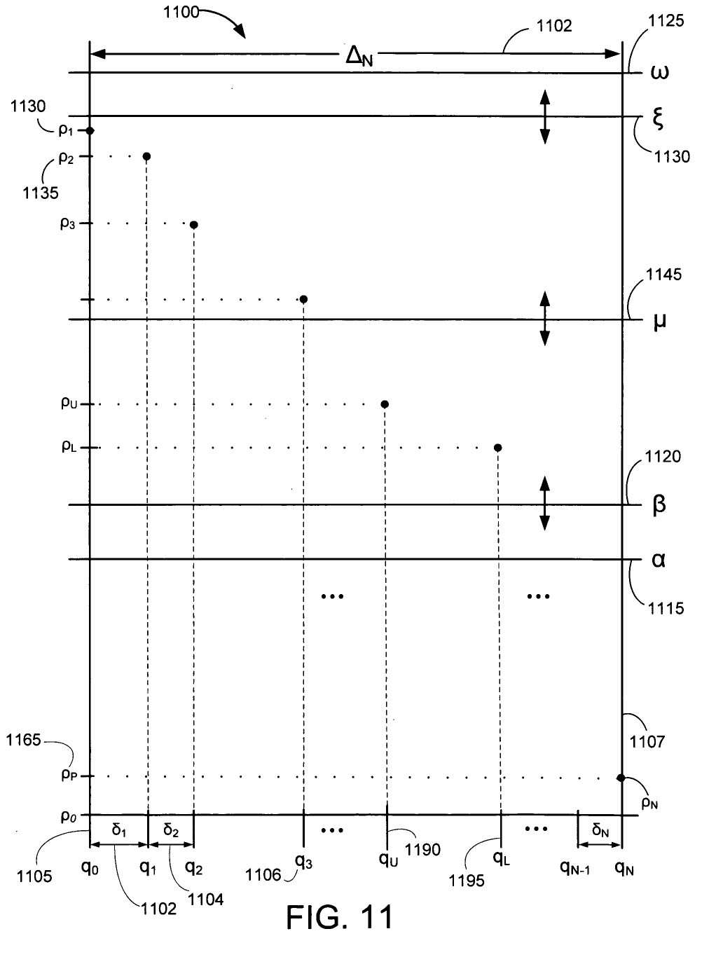

In FIG. 11, a trade object inventory level is the trade dimension to which the exemplary adaptive stochastic transaction process 1100 responds. That is, trade object price generally corresponds to trade object inventory. Similarly, trade interval Δ_{N} 1102 is related to trade object inventory, in that trade interval Δ_{N} 1102 can end upon exhaustion of a predefined trade inventory. At the onset of the first interval δ₁, trade object inventory is measured to be quantity, q₀. During this interval δ₁, trade object price can be held at first value ρ₁. Responsive to measured inventory, for example, Transaction Driver function Z may be used to adjust trade object value ρ. As in the foregoing examples and embodiments, at least one of a trading interval δᵢ and a trade object price ρᵢ, constitute a stochastic decision tuple <δ,ρ>, with which a Buyer may decide to purchase the offered trade object at the trade object price then represented by trade object price ρᵢ.

In certain embodiments using Transaction Driver function Z, measured dimensions constituting Transaction Driver function Z may signal a special trading event in which trade object price will be driven down until trade inventory reaches the preselected minimum quantity, q_{N}. At the end of interval Δ_{N}, which includes the aforementioned special trading event, the corresponding trade object price can be ρ_{N}. Thus, when trade object inventory reaches quantity q_{N}, prospective buyers who transmit a COMMIT token, indicating a desire to buy the trade object during the special trading interval, may purchase trade objects at the final trade object price ρ_{N}, even if a prospective buyer transmitted a COMMIT token corresponding to a trade object purchase price greater than ρ_{N}. However, prospective purchasers who do not transmit a COMMIT token prior to the completion of special trading interval, as marked by trade object inventory reaching the quantity q_{N}, can be precluded from purchasing the trade object at final trade object price ρ_{N}.

In selected embodiments, trade object price ρᵢ ε {ρ₁, . . . , ρ_{N}} may fluctuate stochastically for at least a portion of trading event Δ_{N} 1102, evoking the principles set forth above. In FIG. 11, trading event Δ_{N} 1102, is not defined over time, but over a preselected quantity of trade object inventory. Thus, where q₀ 1105 corresponds to an exemplary initial inventory quantity, and q_{N} 1107 corresponds to an exemplary target, or final, inventory quantity, trading event Δ_{N} 1102 can correspond to a preselected inventory reduction quantity. That is, Δ_{N} \hat{=}q₀−q_{N}. In such a case, each trading interval δᵢ ε {δ₁, . . . , δ_{N}} can correspond to an incremental inventory change, e.g., δ_{N}\hat{=}q_{N-1} −q_{N}. Also, successive trading intervals δᵢ can correspond to fixed and equal incremental inventory changes, or to one or more incremental inventory change that varies deterministically or, at least in part, stochastically. By extension, although trading event Δ_{N} 1102 is illustrated to be generally fixed or strictly defined, embodiments of the present invention also contemplate an extensible trading event Δ_{N} 1102, in which target, or final, inventory quantity q_{N} 1107, is changed, e.g., lowered, to permit additional buyers to commit to purchasing the offered trade object.

In this example, a stochastic sequence generator (not shown but may be similar to stochastic sequence generator 602 in FIG. 6, stochastic sequence generator 702 in FIG. 7, or stochastic sequence generator 802 in FIG. 8), may be used to generate a signal value for Transaction Driver function Z from one or more selected trade indicators constituent of Transaction Driver function Z. Where constituent trade indicators of Transaction Driver function Z combine to approximate the Operational function δₓ, Transaction Driver function Z can drive to substantially zero the second term of the expression
ρ_{N}∝ρ_{P}+∂ₘ(∂ₓ−Z)

where ρ_{N} is the offered trade object value or price;
ρₚ. is a desired minimum price, similar to a reserve price;
δₘ is a desired margin value desired by a business operator;
δₓ is an Operational function, constituted of at least a first one of a selected trade indicator; and
Z is the Transaction Driver function, constituted of at least a second one of a selected trade indicator.

Thus, in the example where δₓ≅Z, ρ_{N}≅ρₚ. Operational function, δₓ, may vary price, ρᵢ, generally between desired ceiling price ┌ω┐ 1125 and desired floor price └α┘ 1115, perhaps urging price ρᵢ toward desired mean trade offer value μ 1145. During a trading event, price ρᵢ also may be provided within an envelope of values generally defined within the range of upper envelope bound ξ 1130 and lower envelope bound β 1120, where the envelope generally tends toward desired mean trade offer value μ 1145. It is to be understood that upper envelope bound ξ 1130, lower envelope bound β 1120, mean trade offer value μ 1145, and trade offer price, or value, ρᵢ, may correspond to an Operational function, δₓ, that is linear, nonlinear, or a combination thereof. There is no constraint that requires price ρ_{N} to instantaneously drop to ρₚ. Instead, ρ_{N} may decline in accordance with the manner in which the constituent trade indicators and dimensions of Operational function δₓ and Transaction Driver function Z provide. It is desirable, when Z=δₓ, that the signal value representative of special trading event is communicated.

During a special trading event, trade object price ρᵢ may decrease at an essentially constant rate, at a stochastically variable rate, or at an inventory-dependent rate. The rate of change of ρᵢ can be adapted, in some instances in real-time or near-real time, to be responsive to aggregate buyer response and pertinent trade indicators. As the trade object price declines, e.g., from ρ₂ to ρ₃, a first prospective buyer may be eager to purchase a trade object at price ρ₃ which is higher price than ρ_{N}, and so indicates this desire by transmitting back to the seller a COMMIT token corresponding to the higher trade object value of ρ₃. By sending a COMMIT token, a prospective buyer tends to decrease trade object inventory by the number of trade objects corresponding to the COMMIT token. In general, q₂<q₁.

A second prospective buyer may indicate an acceptance of the sellers' offer to purchase by transmitting a COMMIT token after the first prospective buyer, with the second buyer's COMMIT token corresponding to an accepted trade object price or value ρ₄, generally lower than the trade object value ρ₃. accepted by the first prospective buyer. This second prospective buyer, too, decreases available trade object inventory. Likewise, in general, q₃<q₂. As the trade object price ρᵢ continues to decline, additional prospective purchasers indicate a desire to purchase a trade object by transmitting respective tokens to the seller, with additional respective reductions in trade object inventory, in general q_{L}<qᵤ.

Upon the putative exhaustion of inventory, i.e., when trade object inventory reaches quantity q_{N}, the special trading interval, and the trading event defined over interval Δ_{N}, terminates. In desirable embodiments herein, all prospective buyers who committed to purchase a trade object during the special trading event complete the purchase at the final trade object price ρ_{N}, even if the trade object price ρ_{U} at which the respective purchaser transmitted their COMMIT token was higher than final trade object price ρ_{N}. Such a feature can create an “avalanche” effect with buyers, wherein as prices decline, the number of prospective buyers committing to a purchase increases.

By waiting until trade object inventory is exhausted, or nearly so, a prospective purchaser risks not being able to purchase a trade object at all. However, if a prospective purchaser commits to purchase a trade object at the beginning of the special trading event, that purchaser pays no more than the lowest price. In fact, this lowest price is paid by all. The magnitude of final trade object price ρ_{N} is generally a function of the existant price when inventory exhaustion, or quantity q_{N} is reached. Prospective buyers may be motivated by the perception to purchase a trade object at a value favorable to the purchaser, by the excitement generated by the trading event, by the nature of the trade object itself, such as a rare collectible, or by a myriad of factors within the personal knowledge of the prospective buyer. Unlike a Dutch auction where each bidder agrees to buy an item at the bid price and bidding continues until inventory exhaustion or the seller opts to halt the auction to preserve pricing structure, the method herein allows all buyers to take at the final offered trade object price, which was in effect at the predetermined trade event termination, here the exhaustion of an inventory of qₙ trade objects.

Although in the foregoing example, ρ_{N} declined to ρₚ where Transaction Driver function Z was adapted to approximately equal Operational function δₓ, it also is possible that Z can be adapted to have a magnitude greater than δₓ, such that the final price ρ_{N} is less than desired minimum price ρₚ. Such adaptation may be useful where inventory clearance becomes a priority. In an extreme instance ρ_{N}=0, i.e., the trade object is being given away. On the other hand, it also is possible to adapt function Z to maintain a magnitude less than Operational function δₓ. In certain circumstances, it may even be desirable to provide a selected trade indicator or a combination of selected trade indicators such that Transaction Driver function Z is given a negative value, thereby allowing ρ_{N}>>ρₚ. Such an increasing price may be desirable, for example, where buyer activity may exceed what is considered to be acceptable to the seller or business operator or, perhaps on a longer time scale as with a demographic trend, to raise a trade object offer price to accommodate a perceived increase in trade object market value. Again, Transaction Driver function Z and Operational function δₓ, may be constituted of selected trade indicators and trade dimensions, which can be combined to provide a desired rate of adaptation for a single trading event, for an ensemble of trading events, for aggregations of trading event ensembles, and the like.

Nevertheless, exemplary embodiments of the present invention evoking the perception of free-falling prices for a desirable trade object, can be useful for inventory clearance or reduction, for market introduction of new products or vendors, for generation of service or brand awareness, and so forth. Advantageously, purchases under such circumstances can provide consumer, market, and competitor-related business intelligence, in real time during the trading event, in near-real time, or in retrospect. Such data can be directed to influence Transaction Driver function Z, and can be tailored for a particular type of product, communication channel, geographic and demographic factors, and current consumer and market trends. Such data also can provide valuable enterprise intelligence, also on a real-time, a near-real-time, or a retrospective basis, assisting the enterprise to beneficially adapt to its trading milieu.

While the present invention has been described with respect to particular physical embodiments, the invention is not limited to the particulars described above; instead, the scope of the invention is defined by the following claims.

1. A trading system, comprising:
a vendor disposed to propose an object offer at an offer value;
a vendee disposed to accept the object offer at a purchase value;
a communication link coupling the vendor and the vendee, whereby the vendor and the vendee communicate data relative to an object offer;
wherein the vendor proposes the object offer to the vendee through the communication link;
wherein the data relative to an object offer includes a stochastic tuple related to the offer value; and
wherein the vendee is induced to accept the object offer having the offer value being one of generally equal to and less than the purchase value.

2. The trading system of claim 1, wherein the stochastic tuple comprises a proposed offer value and an offer interval.

3. The trading system of claim 2, wherein one of the proposed offer value and the offer interval comprises a stochastic variable value.

4. The trading system of claim 3, wherein the offer interval is a stochastic variable value.

5. The trading system of claim 4, wherein the proposed offer value is a stochastic variable value.

6. The trading system of claim 5, wherein the proposed offer value is a stochastic variable value.

7. The trading system of claim 2, wherein the tuple comprises both a stochastic offer interval and a stochastic offer value.

8. The trading system of claim 1, further comprising a sequence of stochastic tuples communicated by the vendor to the vendee during a defined transaction period.

9. The trading system of claim 1, wherein the vendee accepts the object offer at the purchase value responsive to a selected one of the sequence of stochastic tuples, the purchase value corresponding to a proposed offer value comprising the selected one of the sequence of stochastic tuples.

10. The trading system of claim 2, wherein the vendor proposes the object offer to a plurality of vendees through the communication link.

11. The trading system of claim 10, further comprising a sequence of stochastic tuples communicated by the vendor to the plurality of vendees during a defined transaction period.

12. The trading system of claim 11, wherein one of the plurality of vendees accepts the object offer at the purchase value responsive to a selected one of the sequence of stochastic tuples, the purchase value corresponding to a proposed offer value comprising the selected one of the sequence of stochastic tuples.

13. The trading system of claim 12, wherein selected tuples of the sequence of stochastic tuples comprise both a stochastic offer interval and a stochastic offer value.

14. The trading system of claim 13, further comprising:
an object manager adapting a selected vendor object property responsive to one of data relative to the object offer, the vendor, and the vendee; and
one of
an operations communication link coupling the vendor and the object manager, whereby the vendor and the object manager communicate data relative to the object offer; and
a commerce communication link coupling the vendee and the object manager, whereby the vendee and the object manager communicate data relative to the object offer.

15. The trading system of claim 10, wherein the vendor proposes the object offer within a preselected marketing schema, wherein the preselected marketing schema entices the vendee to receive the object offer of the vendor, and wherein the preselected marketing schema comprises an interactive, multimedia entertainment schema.

16. The trading system of claim 1, wherein the object offer represents one of a product, a service, and a combination thereof.

17. A transaction system, comprising a first transactor and a second transactor coupled by a communication route, wherein the first transactor signals a stochastic decision tuple to the second transactor, and wherein the stochastic decision tuple induces a behavior in the second transactor.

18. A method for effecting a transaction of an object offered at a offer value by a first transactor being accepted by a second transactor, comprising:
a. generating a stochastic tuple corresponding to the offer value by the first transactor;
b. communicating the stochastic tuple from the first transactor to the second transactor;
c. receiving the stochastic tuple by the second transactor, the stochastic tuple representing the offer value and an offer limit;
d. considering the offer value by the second transactor; and
e. if the second transactor accepts the object offered at the offer value, then the second transactor accepting the object responsive to the offer limit.

19. A transaction system, comprising a first transactor and a second transactor coupled by a communication route, wherein the first transactor signals a stochastic decision tuple to the second transactor, and wherein the stochastic decision tuple induces a behavior in the second transactor.

20. A transaction system, comprising a first transactor and a second transactor coupled by a communication route, wherein the first transactor generates a plurality of stochastic decision tuples selectively drawn from respective plural stochastic generation processes having predetermined process distribution envelopes, wherein the first transactor signals a stochastic decision tuple to the second transactor, wherein the stochastic decision tuple induces a behavior in the second transactor, wherein the behavior in the second transactor is one of a plurality of business indicators, and wherein the transaction system is adaptively responsive to selected business indicators to maximize an enterprise parameter.

21. A trading system, comprising:
a vendor disposed to propose an object offer at a first offer value;
a vendee disposed to accept the object offer at a second offer value with a value magnitude less than the first offer value;
a communication link coupling the vendor and the vendee, whereby the vendor and the vendee communicate data relative to an object offer;
a stochastic sequence generator generating at least one of the first offer value and the second offer value in response to a preselected Transaction Driver function Z;
wherein the vendor proposes the object offer to the vendee through the communication link;
wherein the data relative to an object offer includes a stochastic tuple related to the offer value;
wherein the preselected Transaction Driver function Z corresponds to predetermined trade dimensions; and
wherein the vendee is induced to accept the object offer in which the second offer value is generally less than the first offer value.

22. A method for a transaction system, comprising:
generating a sequence of trade object offer values for a trade object responsive to a preselected Transaction Driver function Z by a prospective seller, wherein the preselected Transaction Driver function Z corresponds to predetermined trade dimensions and at least a portion of ones of the trade object value being an adaptively stochastic value;
sequentially transmitting ones of the sequence of trade object offer values to the prospective buyer from the prospective seller over a communication link;
sensing a reply over the communication link from the buyer to ones of the sequence of trade object offer values; and
responsive to a reply indicative of acceptance, completing a transaction for the trade object at one of the trade object offer value selected by the prospective buyer.

23. A transaction system among a buyer, a seller, and business operation, comprising:
a stochastic tuple generator generating a stochastic tuple representative of an offered trade object price for an offered trade object;
a first communication channel including a first link through which the buyer perceives the stochastic tuple signaled by the seller and a second link through which the buyer indicates to the seller acceptance of the offered trade object at the offered trade object price;
a second communication channel including a third link between the buyer and the business operation through which the buyer tenders to the business operation a desired medium of exchange corresponding to the offered trade object price and a fourth link through which the seller and the business operation communicate selected business indicators responsive to a response of the buyer.

24. The transaction system of claim 23, wherein the offered trade object is offered for sale to the buyer over a trading event wherein the stochastic tuple generator sequentially produces for communication to the buyer a sequence of offered trade object prices, wherein ones of the offered trade object prices vary at least in part stochastically during the trading event.

25. The transaction system of claim 24, further comprising a Transaction Driver function representative of at least one selected trade indicator, wherein Transaction Driver function adapts at least one offered trade object price in response to the at least one selected business indicator.

26. The transaction system of claim 25, wherein the trading event is a defined over non-temporal dimension.

27. The transaction system of claim 26, wherein the Transaction Driver function adapts the at least one offered trade object price to induce a desired behavior in the buyer.

28. The transaction system of claim 25, wherein the Transaction Driver function adapts the at least one offered trade object price to induce a desired behavior in the buyer.

29. The transaction system of claim 25, wherein the trading event is at least partly defined over time.

30. The transaction system of claim 28, wherein the Transaction Driver function causes a present offered trade object price to vary at least partly stochastically, and wherein the present offered trade object price is one of greater than or lesser than a previous offered trade object price.

31. The transaction system of claim 30, wherein the Transaction Driver function causes the present offered trade object price to be substantially less than a previous offered trade object price, wherein the present offered trade object price and the previous offered trade object price are at least partly generated stochastically.
